(19) United States
(12) Patent Application Publication
(10) Pub. No.: US 2006/0007215 A1
(43) Pub. Date: Jan. 12, 2006

(54) Display device

(75) Inventors: Youichi Tobita, Hyogo (JP); Masafumi Agari, Hyogo (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Mitsubishi Denki Kabushiki Kaisha, Tokyo (JP)

(21) Appl. No.: 11/147,370

(22) Filed: Jun. 8, 2005

(30) Foreign Application Priority Data
Jun. 18, 2004 (JP) 2004-181351

(51) Int. Cl. G09G 5/00

(52) U.S. Cl. 345/204

(57) ABSTRACT

A plurality of data lines are provided for pixels arranged in one column. One of the data lines is precharged to a predetermined voltage, and a write current of a voltage corresponding to black data is supplied to a selected pixel via another data line. These data lines are connected to the pixels in different rows in a predetermined sequence. A display device capable of writing a complete black signal without impairing a margin for a write time can be provided.

### BACKGROUND OF THE INVENTION

1. Field of the Invention

The present invention relates to a display device, and particularly to a construction for reducing power consumption of a display device using electro-luminescence elements (which will be referred to as “EL elements” hereinafter) as pixels. More particularly, the invention relates to a construction, which achieves writing of black data of the display device without reducing a margin for a write time.

2. Description of the Background Art

The EL element has a radiant intensity determined by a driving current. By changing an amount of the drive current according to write data, a luminance of a pixel can be set according to a display image, and gradational display can be performed.

If the number of pixels is increased for improving an image quality of the display device using such EL elements, the number of scan lines increases so that a write time for each pixel decreases. Further, increase in number of the pixels increases the current consumption.

Prior art reference 1 (Japanese Patent Laying-Open No. 2002-214645) discloses a construction, in which data lines arranged corresponding to respective pixel columns in a display panel are divided. This construction reduces the number of pixels connected to each divided data line, and accordingly reduces a parasitic capacitance of interconnections so that a power required for charging and discharging the data lines is reduced. In each pixel column, data are simultaneously written in pixels connected to different divided data lines, respectively, and thereby the pixel write time is increased so that the write margin is improved. In each pixel column, the divided data lines are arranged on the either side of the pixel so that a portion, where the divided data lines cross each other, is removed, and capacitance coupling between the divided data lines is eliminated, in order to suppress increase in parasitic capacitance of the divided data lines.

Prior art reference 2 (Japanese Patent Laying-Open No. 62-054291) discloses a construction, in which gate lines arranged in respective pixel rows are grouped into pairs, and the two gate lines in each pair are short-circuited via a switching element. One gate line driver drives paired two gates. This prior art reference 2 aims to reduce gate line drive circuits, for reducing the number of circuit components so that current consumption is reduced.

Prior art reference 3 (Japanese Patent Laying-Open No. 2003-043997) relates to a constant current drive method of organic EL elements, and discloses a construction for rapidly setting the organic EL elements to a desired light emitting state. In this prior art reference 3, the construction has a precharge current supply, which precharges internal parasitic capacitances of the organic EL elements, and a data write current supply supplying a constant current to the organic EL element in a data write operation. According to the construction disclosed in prior art reference 3, data writing is performed in a PWM (Pulse Width Modulation) method, and the internal parasitic capacitance of the organic EL element is precharged. Thereby, in the data write operation, fast driving is performed from the charged voltage of the internal parasitic capacitance to the desired luminance voltage level, and the luminance of the organic EL element can be rapidly stabilized.

Prior art reference 4 (Japanese Patent Laying-Open No. 2003-223140) discloses a device for driving EL elements in a PAM (Pulse Amplitude Modulation) method or the PWM method, and particularly discloses a construction, in which a circuit for precharging the EL elements according to write data is arranged, and the drive voltage is applied to the organic EL elements according to the write data after the precharging. This prior art reference 4 maintains a desired luminance voltage level at an initial stage of light emission of the organic EL elements, for reducing a variation in luminance.

If the display device is a battery-powered device or the like, it is particularly required to reduce current consumption. From the viewpoint of contrast of the image, it is desired to set a complete “non-emission state”, or a state of emitting no light, for the black display state.

In the construction disclosed in reference 1, the data lines have the divided construction, and the data line drive circuit is provided for each of the divided data lines. This results in a problem of increase in number of the data line drive circuits. In the same column, gate lines in different rows, which cross different divided data lines, respectively, are driven for writing the data, and the gate lines are driven by different drive circuits, respectively. Therefore, it is difficult to achieve accurate matching in selection timing between the gate lines to be selected in parallel so that the data write margin may lower. Further, no consideration is given to the complete black display state.

In the construction disclosed in reference 2, the paired gate lines are short-circuited for transmitting the gate line drive signal. After transmitting the gate line drive signal, each gate line is isolated from the other. Therefore, each gate line drive signal is activated in a doubled cycle of the case of independently driving each gate line. In this case, the gate lines, which are simultaneously driven to the selected state, simultaneously connect the pixels in the two rows to the same data line. Therefore, the first and second gate lines simultaneously connect the pixel elements to the same data line for writing the data. After the writing of the data in the pixels connected to the first gate line is completed, the data is written in the pixels connected to the second gate line. In this operation, the second gate line is in a floating state. Therefore, when the data line is driven according to the write data, capacitance coupling may vary a potential thereof so that accurate data writing cannot be ensured. Further, the complete black display state is not discussed at all.

The construction disclosed reference 3 is intended to increase the write margin by precharging the internal parasitic capacitance of the organic EL element. It is stated in connection with a precharge current amount of the internal parasitic capacitance that a precharge time and a current amount are controlled by a precharge control signal and a precharge current supply bias signal so that the precharge current amount is controlled not to exceed a maximum capacity of a battery (power supply). However, the precharge voltage level of the internal parasitic capacitance is not discussed at all. Further, this reference 3 neither discloses nor suggests a construction for achieving the complete black data display state or a zero current driving state in the organic EL element.

In the construction disclosed in reference 4, a precharge signal at a level (current/voltage level) according to the write data is applied to the organic EL element. In the construction disclosed in reference 4, however, it is merely necessary to set the internal parasitic capacitance of the organic EL element to a precharge level corresponding to the write data. This complicates the circuit configuration. In this reference 4, it is assumed that a current always flow through the organic EL element in a data write operation, and no consideration is given to a problem caused when the organic EL element is set to a non-emission state for improving contrast and others.

### SUMMARY OF THE INVENTION

An object of the invention is to provide a display device, which can perform complete black data writing of setting the organic EL element to a complete non-emission state without reducing a margin for the write time.

Another object of the invention is to provide a display device, which can increase a margin for the write time by reducing a time required for the writing.

A display device according to a first aspect of the invention includes a plurality of pixels, arranged in rows and columns, each including a light emitting element having a light emitting state set by its own drive current; a write circuit for effecting writing on at least one first pixel in the same column according to write data in a common write cycle; and a precharge circuit for effecting precharging on the pixel located in the same column as and a different row from the at least one first pixel in parallel with the writing on the at least one first pixel.

A display device according to a second aspect of the invention includes a plurality of pixels, arranged in rows and columns, each including a light emitting element having a light emitting state set by its own drive current; a plurality of data lines arranged corresponding to the pixel columns such that at least one pair of the data lines is provided per column; a plurality of precharge circuits, arranged corresponding to the pixel columns such that at lease one pair of the precharge circuits is provided per column, each supplying a precharge voltage to the corresponding data line; a plurality of display data write current supply circuits, arranged corresponding to the pixel columns such that at least one display data write current supply circuit is provided per column, each being activated to supply a current of a magnitude according to write data to the corresponding column; and black data write circuits, arranged corresponding to the data lines, each being activated to transmit a potential setting the corresponding data line to a state of stopping current driving by the light emitting element in the selected pixel.

The display device according to the first aspect performs the writing of the image data signal in the selected pixels while precharging the pixels in another row in parallel. Therefore, it is not necessary to provide a time dedicated to the precharging in the write cycle, and the write cycle time can be fully utilized to write the pixel signal. In each selected pixel, the pixel data signal changes from the precharged level, and this precharged voltage level can be set to an appropriate voltage level so that the potential of the internal node can rapidly reach a target voltage level even when a write current assumes a minimum value, and therefore the margin of the write time can be increased.

The display device according to the second aspect of the invention includes the black data write circuit, and can reliably prevent the flow of a current through the light emitting element in writing of black data in the selected pixel. Therefore, the light emitting element can be reliably set to the non-emission state so that contrast of the image can be improved. The pixel bearing the black data consumes no current so that the current consumption can be reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a construction of a pixel used in a display device according to the invention.

FIG. 2 schematically shows a state of the pixel shown in FIG. 1 during data writing.

FIG. 3 schematically shows an internal state of the pixel shown in FIG. 1 during displaying.

FIG. 4 schematically shows a relationship between a write current and an internal write voltage of the display device according to the invention.

FIG. 5 schematically shows a construction of a main portion of the display device according to a first embodiment of the invention.

FIG. 6 is a timing diagram representing an operation of the display device shown in FIG. 5.

FIG. 7 schematically shows a relationship in supply of a write current according to the first embodiment of the invention.

FIG. 8 shows a variation occurring in a gate voltage vg shown in FIG. 7 when a minimum write current is written.

FIG. 9 schematically shows a whole construction of the display device according to the first embodiment of the invention.

FIG. 10 is a timing chart representing an operation of data writing in a display device according to a second embodiment of the invention.

FIG. 11 schematically shows a voltage variation of a data line in one write cycle of the display device according to the second embodiment of the invention.

FIG. 12 schematically shows a construction of a portion generating a control signal of the display device according to the second embodiment of the invention.

FIG. 13 is a timing chart illustrating an operation of a control signal generating unit shown in FIG. 12.

FIG. 14 schematically shows a construction of a main portion of a display device according to a third embodiment of the invention.

FIG. 15 schematically shows a voltage variation of a data line in one write cycle of one pixel in the display device shown in FIG. 14.

FIG. 16 is a timing chart representing an operation of the display device shown in FIG. 14.

FIG. 17 schematically shows a whole construction of the display device according to the third embodiment of the invention.

FIG. 18 shows an example of a construction of a precharge current supply circuit shown in FIG. 17.

FIG. 19 schematically shows an example of a construction of a precharge current switching circuit shown in FIG. 17.

FIG. 20 is a timing chart representing an operation of the precharge current switching circuit shown in FIG. 19.

FIG. 21 schematically shows a construction of a main portion of a display device according to a fourth embodiment of the invention.

FIG. 22 is a timing diagram representing an operation of the display device shown in FIG. 21.

FIG. 23 schematically shows a construction according to a modification of the fourth embodiment of the invention.

FIG. 24 is a timing chart representing an operation of the display device shown in FIG. 23.

FIG. 25 is a timing chart representing an operation of a display device according to a fifth embodiment of the invention.

FIG. 26 schematically shows a construction of a main portion of a display device according to a sixth embodiment of the invention.

FIG. 27 is a timing chart representing an operation of the display device shown in FIG. 26.

FIG. 28 schematically shows a construction of a main portion of a display device according to a seventh embodiment of the invention.

FIG. 29 schematically shows a construction of a main portion of a display device according to an eighth embodiment of the invention.

FIG. 30 schematically shows a construction of a modification of the eighth embodiment of the invention.

FIG. 31 schematically shows a construction of a main portion of a display device according to a ninth embodiment of the invention.

FIG. 32 schematically illustrates a relationship between a write current and a write voltage in the display device shown in FIG. 31.

### DESCRIPTION OF THE PREFERRED EMBODIMENTS

### First Embodiment

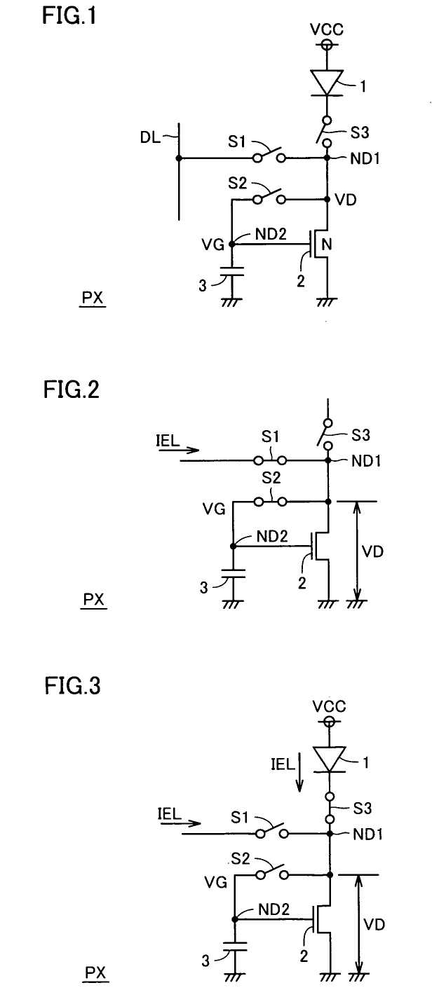

FIG. 1 schematically shows a construction of a pixel PX used in a display device according to the invention. In FIG. 1, pixel PX includes a light emitting element (which will be referred to as an “EL element” hereinafter) 1 having one-side electrode (anode electrode) connected to a power supply node, a switching element S1 connected between a data line DL and an internal node ND1, a switching element S2 connected between internal nodes ND1 and ND2, and made conductive in phase with switching element S1, a switching element S3 connected between EL element 1 and internal node ND1 and made conductive complementarily to switching elements S1 and S2, an N-channel MOS transistor (insulated gate field effect transistor) 2 connected between internal node ND1 and a ground node and having a gate connected to internal node ND2, and a capacitance element 3 connected between internal node ND2 and the ground node.

A light emission intensity of EL element 1 is determined according to its drive current. By setting an amount of the drive current of EL element 1 according to a write data (pixel signal), it is possible to determine a luminance of pixel PX to enable gradation display.

Operations of writing the pixel signal in pixel PX shown in FIG. 1 and emitting light will now be described.

In the operation of writing the pixel signal, switching elements S1 and S2 are turned on as shown in FIG. 2, and switching element S3 is turned off. In this state, data line DL supplies a current IEL corresponding to the pixel signal. As can be seen from an electrically equivalent circuit in FIG. 2, MOS transistor 2 in this state has a gate and a drain connected together, and is in a diode-connected state so that it operates in a saturation region. A relationship between a gate voltage VG (equal to a drain voltage VD) of MOS transistor 2 and a current IEL is expressed by the following formula (1):
IEL=β·(VG−VTN)²/2 (1)
, where β represents a current amplification coefficient of transistor 2, and VTN represents a threshold voltage of transistor 2.

From the above formula (1), gate voltage VG and drain voltage VD are expressed by the following formula:
VG=VD=VTN+(2·IEL/β)^{1/2} (2)

Thus, gate voltage VG (drain voltage VD) attains a level of a voltage obtained by adding an amount of the voltage rising, which is caused by write current IEL corresponding to the pixel signal, to threshold voltage VTN of MOS transistor 2.

Since switching element S1 is on, data line DL attains the voltage level of voltage VD (=VG). Capacity element 3 holds this gate voltage VG.

When writing of the pixel signal is completed, a light emitting state (display state) starts. In this display state, switching elements S1 and S2 are turned off, and switching element S3 is turned on as shown in FIG. 3. In this state, capacitance element 3 holds voltage VG represented by the formula (2), and MOS transistor 2 drives a current according to its gate voltage VG. EL element 1 has the voltage-current characteristics set to satisfy the relation of (VD≧VG−VTN) for having a current supply capability of operating MOS transistor 2 in the saturation region.

Therefore, MOS transistor 2 operates in the saturation region, and a drain current thereof becomes equal to current IEL supplied via the data line in the write operation. The current flowing through MOS transistor 2 is supplied from EL element 1, and the drive current of EL element 1 becomes equal to current IEL so that EL element 1 enters the light emitting state corresponding to the written pixel signal.

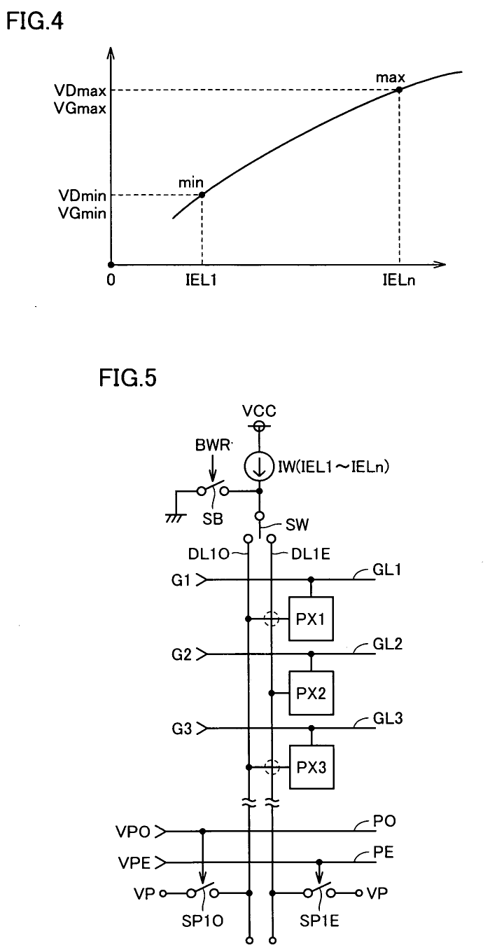

FIG. 4 illustrates a write state of the pixel circuit. More specifically, it represents a relationship of voltages VD and VG on the internal nodes of pixel PX with respect to the current flowing through EL element 1. In FIG. 4, the abscissa gives the current flowing through EL element 1, and the ordinate gives voltages VD and VG on the internal nodes. As illustrated in FIG. 4, one of currents IEL1-IELn at discrete levels is supplied as a pixel signal. When minimum write current IEL1 is supplied, minimum voltages VDmin and VGmin are set on the internal nodes, respectively. When maximum write current IELn for the maximum luminance flows, maximum voltages VDmax and VGmax are set on the internal nodes, respectively.

For setting EL element 1 to the black display state, current IEL is set to zero. In this case, if the data line is not precharged, and is maintained in a floating state, the gate and drain of MOS transistor 2 are discharged in the black data write operation. MOS transistor 2 is turned off when its gate and drain voltages become equal to threshold voltage VTN. In this case, however, MOS transistor 2 does not enter the complete off state, and a leakage current (subthreshold current) flows. In this state, therefore, EL element 1 cannot be set to the complete non-emission state in which light emission is completely stopped.

For avoiding such state, the voltages VD and VG on internal nodes are set to 0 V. Thereby, MOS transistor 2 can be reliably kept non-conductive so that the current does not flow through EL element 1, and EL element 1 can be set to the black display state. If minimum write current IEL1 is supplied in the next cycle in the operation of writing the black data, a long write time is required for driving the gate potential of MOS transistor 2 from the ground voltage to the voltage level of driving minimum write current IEL1. For reducing this write time, the data line is precharged to a predetermined potential according to the invention, so that writing of the black data and fast writing of the minimum luminance data are achieved.

FIG. 5 schematically shows a construction of a main portion of a display device according to the first embodiment of the invention. FIG. 5 shows a construction of a portion provided for the pixels arranged in one column. Specifically, FIG. 5 representatively shows three pixels PX1-PX3 among those arranged in one column.

Gate lines GL (GL1, GL2 and GL3) are arranged corresponding to the respective rows of the pixels. Gate line drive signals G (G1-G3) on gate lines GL1-GL3 control the on/off or conductive/non-conductive state of switching elements S1 and S2 shown in FIG. 1. A gate control line controlling the on/off state of switching element S3 shown in FIG. 1 is arranged parallel to gate lines GL1-GL3. For the sake of simplicity, FIG. 5 does not show the gate control line for controlling switching element S3 shown in FIG. 1. The gate control line and each of gate lines GL1-GL3 receive mutually complementary signals. In FIG. 5, gate lines GL1-GL3 receive gate line drive signals G1-G3, respectively.

Corresponding to each pixel column, an odd-numbered data line DL1O connected to pixels PX1, PX3 . . . in odd-numbered rows and even-numbered data line DL1E connected to pixels PX2 . . . in the even-numbered rows are arranged parallel to each other.

A selection switch SW for writing is arranged on one side of data line DL1O (or DL1E). Selection switch SW is connected to a write constant current source IW and a black data write switch SB. Write constant current source IW supplies a current at one of levels of currents IEL1-IELn according to the write pixel signal. In the black data write operation, black data write switch SB is turned on in response to a black data write instruction signal BWR, and transmits, e.g., a ground voltage. In this black data write operation, write constant current source IW is inactive, and its output node is maintained in a floating state.

When black data write switch SB is on, it transmits the ground potential. However, this black data write voltage may be at a voltage level other than the ground voltage level provided that the voltage level can maintain MOS transistor 2 shown in FIG. 1 in the off state.

On the other side of data line DL1O or DL1E, precharge switching elements (i.e., switching elements for precharging) SP1O and SP1E are arranged. Precharge switching element SP1O is selectively turned on according to a precharge instruction signal VPO on a precharge control signal line PO, and accordingly transmits precharge voltage VP onto odd-numbered data line DL1O. Precharge switching element SP1E is selectively turned on according to precharge control signal VPE on precharge control signal line PE, and thereby transmits precharge voltage VP onto even-numbered data line DL1E.

Precharge voltage VP, as will be described later in greater detail, is at the voltage level equal to or higher than minimum write voltage VDmin (VP≧VDmin, VGmin).

According to the first embodiment of the invention, when one of data lines DL1O and DL1E supplies a write current, the other is supplied with precharge voltage VP. Thereby, the writing of black data is performed, and the fast writing is achieved.

A circle of broken line shown at each crossing between data lines DL1O and DL1E represents a line capacitance formed between data lines DL1O and DL1E.

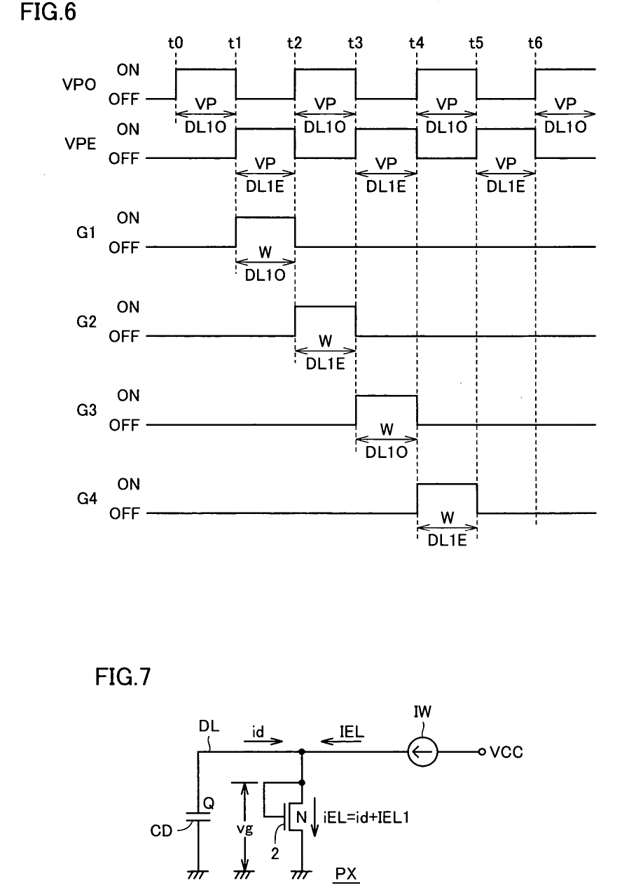

FIG. 6 is a timing chart representing an operation of a display device shown in FIG. 5. Referring to FIG. 6, an operation of the display device shown in FIG. 5 will now be described.

At a time to, precharge control signal VPO attains an H level (logical high level), and precharge switch SP1O is turned on to transmit precharge voltage VP to odd-numbered data line DL1O. Thus, assuming that black data is written immediately before writing the data in the pixel, data lines DL (DL1O and DL1E) are unconditionally supplied with precharge voltage VP in a cycle before the writing in every pixel.

It is most preferable to set precharge voltage VP at the level of minimum write voltage VDmin. However, variations occur in threshold voltage between MOS transistors 2 in pixels PX, and therefore variations occur in minimum write voltage VDmin between the pixels. In an operation of writing minimum write current IELmin in a given pixel, if precharge voltage VP is lower than minimum write voltage VDmin of the given pixel, a voltage difference of (VDmin−VP) must be charged with minimum write current IEL1. A charging time tw of the data line for such charging is expressed by the following formula:
tw=CD·(VDmin−VP)/IEL1
, where CD is a parasitic capacitance of data line DL1O or DL1E.

Assuming that data line capacitance CD is 10 pF, minimum write current IEL1 is 10 nA, and a voltage difference (VDmin−VP) due to variations in threshold voltage is 0.5 V, charging time tw is expressed by the following formula:
tw=(10×10⁻¹²×0.5)/10×10⁻⁹=500(μS)

Usually, an allowable value of charging time tw of the data line is of the order of tens of microseconds. Therefore, the above condition that the charging time tw is equal to 500 μS is not allowed, and the foregoing condition of precharge voltage VP is not allowed.

In the operation of charging the data line, minimum write current IEL1 defines the write time. In the operation of discharging the data line, a conductance of MOS transistor 2 in pixel PX defines the discharging time. Therefore, the discharging time can be reduced by increasing a conductance in MOS transistor 2. The magnitude of conductance of the MOS transistor primarily depends on a gate width of the MOS transistor. Although the gate width is limited depending on the size of pixel PX, a usual size of the pixel sufficiently allows the setting of the discharging time to tens of microseconds. Therefore, precharge voltage VP is set with the possible maximum value of minimum write voltage VDmin in mind while giving consideration to the voltage levels of minimum write voltages VDmin of all the pixels (VP≧MAX(VDmin)).

At time t0, selection switch SW is isolated from data lines DL1O and DL1E.

At a time t1, selection switch SW is connected to odd-numbered data line DL1O. Write constant current source IW can supply a current between a first gradation level (minimum write current IEL1) and an n-th gradation level (maximum write current IELn). At time t1, gate line drive signal G1 attains the H level so that switching elements S1 and S2 of the pixels connected to gate line GL1 are turned on, and write constant current source IW supplies a current (e.g., minimum write current IEL1) of the amount according to the write pixel signal to MOS transistor 2 provided for storing the current value in the selected pixel. Thereby, the voltage level of odd-numbered data line DL1O changes toward the voltage level of minimum write voltage VDmin peculiar to MOS transistor 2 in the pixel.

At time t1, precharge control signal VPE attains the H level so that precharge switching element SP1E is turned on to supply precharge voltage VP to even-numbered data line DL1E. In this state, precharge control signal VPO is at the L level (logical low level), and precharge switching element SP1O is off. Thereby, in parallel with the writing of the pixel signal in pixel PX1, the even-numbered data line is precharged to effect the precharging on next pixel PX2.

After the write cycle for pixel PX1 is completed, gate line drive signal G1 attains the L-level at a time t2, and gate line drive signal G2 for next pixel PX2 rises to the H level. In this state, precharge control signals VPO and VPE attain the H- and L-levels, respectively. Selection switch SW is connected to even-numbered data line DL1E. In this case, therefore, data line DL1E is supplied with the write current provided from write constant current source IW or the ground voltage supplied from black data write switch SB. Odd-numbered data line DL1O is supplied with precharge voltage VP via precharge switching element SP1O. For write constant current source IW, a control circuit (not shown) sets a write current value corresponding to the write pixel signal, and the write current thus set is supplied to current value storage MOS transistor 2 (i.e., MOS transistor for current value storage) in pixel PX2 via even-numbered data line DL1E so that the gate voltage thereof is set to the voltage level, which causes a flow of current IEL according to the write pixel signal (in the case other than black data writing). In the operation of black data writing, the write constant current source is set to the inactive state, and black data write switch SB discharges precharge voltage VP to set data line DL to the ground voltage level.

At and after a time t3, similar operations are repeated, and the precharging and writing are executed on all the rows in the pixel array.

Therefore, the time required for writing in all the rows in one frame (field) is longer by a time, which is required for first precharging of the odd-numbered data line DL1O, i.e., a time between times t0 and t1 in FIG. 6 than that in the construction provided with only one data line, and thus this time required for writing in all the rows is nearly equal to that in the conventional construction.

Referring to an electrically equivalent circuit shown in FIG. 7, the precharging and writing operations will now be quantitatively analyzed. FIG. 7 shows write voltage storage MOS transistor 2 (i.e., MOS transistor for storing the write voltage) of pixel PX. Data line DL is connected to a parasitic capacitance CD, write constant current source IW supplies write current IEL, and the parasitic capacitance supplies a precharge current id. It is now assumed that data line DL has been precharged to voltage VP, and write constant current source IW supplies minimum write current IEL1 so that the gate voltage of MOS transistor 2 changes to minimum write voltage VDmin.

In the write operation for pixel PX, discharge current id supplied from data line capacitance CD and minimum write current IEL1 (constant current) supplied from write constant current source IW flow through MOS transistor 2. Discharge current id flowing from data line capacitance CD is expressed by the following formula:
id=−dQ/dt (9)

In the above formula (9), a sign “−” represents the discharge. Q represents accumulated charges in data line capacitance CD. Write current supply IW supplies minimum write current IEL1. Therefore, a current iEL flowing through MOS transistor 2 is expressed by the following formula:
iEL=−dQ/dt+IEL (10)

In the operation of writing the pixel signal in pixel PX, data line capacitance CD and gate voltage vg of MOS transistor 2 are equal to each other so that accumulated charges Q of data line capacitance CD satisfy a relationship of (Q=CD·vg). By substituting this relationship formula into the above formula (10), the following formula (11) is obtained:
iEL=−CD·dvg/dt+IEL1 (11)

Current iEL flowing through MOS transistor 2 is expressed by the following formula:
iEL=beta·(vg−VTN)²/2 (12)

The following formula is obtained from the above formulas (11) and (12):

$$- ( 2 \cdot CD / β ) \cdot ⅆ vg / ⅆ t + 2 \cdot IEL1 / β = {( vg - VTN )}^{2} \qquad ( 13 )$$

By substituting Va² for 2·IEL1/β (2·IEL1/β=Va²), the above formulas (13) can be changed into the following formula (14):
−dvg/{(vg−VTN)²−Va²}=(β/2·CD)·dt (14)

By integrating both sides of the formula (14), the following formula (15) is obtained:

$$- ( 1 / 2 \cdot Va ) \cdot ln \{ ( vg - VTN - Va ) / ( vg - VTN + Va ) \} = ( β / 2 \cdot CD ) \cdot t + K \qquad ( 15 )$$

where K is an integration constant. The following formula (16) is obtained from the formula (15).

$$\begin{matrix}( vg - VTN - Va ) / ( vg - VTN + Va ) = exp \{ ( - Va \cdot β / CD ) \cdot t - \\ 2 \cdot Va \cdot K \} \\ = [ exp \{ ( - Va \cdot β / CD ) \cdot t \} ] \cdot \\ [ exp ( - 2 \cdot Va \cdot K ) ]\end{matrix} \qquad ( 16 )$$

At start point (t=0) of the writing, gate voltage Vg is equal to a precharge voltage VP, and the following formula (17) is obtained from the formula (16):

$$\begin{matrix}exp ( - 2 \cdot Va \cdot K ) = ( VP - VTN - Va ) / ( VP - VTN + Va ) \\ = \begin{matrix}A , & & 0 < A < 1\end{matrix}\end{matrix} \qquad ( 17 )$$

By substituting the above formula (17) into the formula (16), the following relationship is obtained:

$$( Vg - VTN - Va ) / ( Vg - VTN + Va ) = A \cdot exp \{ ( - Va \cdot β / CD ) \cdot t \} \qquad ( 18 )$$

By arranging the formula (18) with respect to gate voltage vg, the following formula (19) is obtained:
vg=(VTN+Va)/[1−A·exp{(−Va·β/CD)·t}]−(VTN−Va)·A·exp{(−Va·β/CD)·t}[1−A·exp{(−Va·β/CD)·t}] (19)

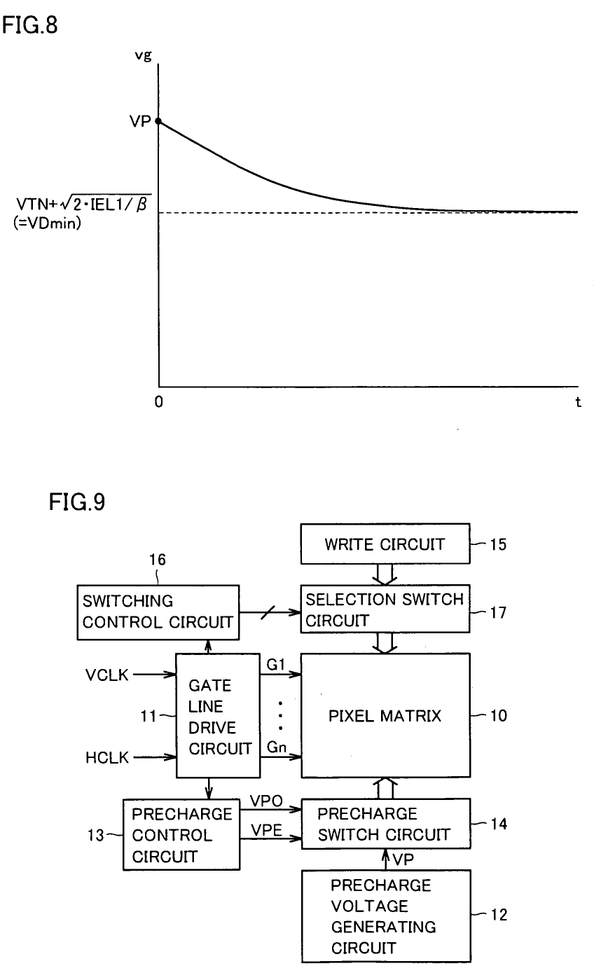

FIG. 8 represents a relationship between gate voltage vg and time t expressed in the formula (19). In FIG. 8, the abscissa gives time t, and the ordinate gives gate voltage vg.

As shown in FIG. 8, the exponential term in the formula (19) approaches zero with time t, and gate voltage vg finally reaches voltage level VGmin corresponding to minimum write current IEL1. If time t is set infinite in the formula (19), gate voltage vg reaches the potential at the level represented by the following formula (19):

$$\begin{matrix}vg \approx VTN + Va \\ = VTN + {( 2 \cdot IEL1 / β )}^{1 / 2} \\ = VD min ( = VG min )\end{matrix} \qquad ( 20 )$$

The above formula (20) is the same as formula (2) already described. This means that the influence of the discharge current flowing from data line capacitance CD decreases with time t, and only the influence of the current supplied from write constant current source IW appears with time t. Thus, the voltages on the gate and drain of the voltage storing MOS transistor 2 in pixel PX are set to the voltage levels according to the write current IEL supplied from write constant current source IW.

For writing the black data, black data write switch SB shown in FIG. 5 discharges precharge voltage VP so that data line DL attains the ground voltage level. In this case, therefore, precharge voltage VP is discharged according to the time constant defined by the line resistance and parasitic capacitance CD of data line DL.

In the operation of writing the black data, black data write switch SB forces data line DL to the ground voltage level, and the drain and gate voltages of MOS transistor 2 of pixel PX are set to the ground voltage level. Thereby, the drain voltage of MOS transistor 2 can be prevented from being maintained at the voltage level of its threshold voltage VTN during the black display. Therefore, the corresponding EL element is reliably prevented from entering a state of driving the current, and can be set into the complete non-emission state.

FIG. 9 schematically shows a construction of a main portion of a display device according to the first embodiment of the invention. Referring to FIG. 9, the display device includes a pixel matrix 10 having a plurality of pixels (PX) arranged in rows and columns, a gate line drive circuit 11, which operates according to vertical and horizontal clock signals VCLK and HCLK to drive successively gate line drive signals G1-Gn driving the gate lines in pixel matrix 10, a precharge voltage generating circuit 12 for producing precharge voltage VP, a precharge control circuit 13 producing precharge control signals VPO and VPE according to a timing signal provided from gate line drive circuit 11, a precharge switch circuit 14 according to precharge control signals VPO and VPE supplied from precharge control circuit 13 for switching the transmission path of precharge voltage VP for the data lines arranged corresponding to the respective columns in pixel matrix 10, a switching control circuit 16 for producing a data line switching control signal according to the timing signal applied from gate line drive circuit 11, a write circuit 15 for producing the write current or the ground voltage according to the pixel signal (not shown), and a selection switch circuit 17 for selecting the transmission path of the pixel signal applied from write circuit 15 according to the switching control signal applied from switching control circuit 16.

Vertical clock signal VCLK determines the display cycle of the screen, and all the rows (gate lines) in pixel matrix 10 are set to the selected state once within one cycle of vertical clock signal VCLK. Horizontal clock signal HCLK defines the active period of the gate line, and determines the horizontal scan period of the screen.

In pixel matrix 10, pixels PX shown in FIG. 5 are arranged in rows and column, data lines DLiO and DL1E are arranged corresponding to each column, and gate lines GL are arranged corresponding to the respective pixel rows.

Gate line drive circuit 11 is formed of, e.g., a shift register, and has its driving sequence set to an initial value in response to reception of vertical clock signal VCLK, and performs the shifting operation in accordance with horizontal clock signal HCLK for successively driving gate line drive signals G1-Gn to the selected state.

Precharge control circuit 13 successively drives precharge control signals VPO and VPE to the selected state according to the timing signal received from gate line drive circuit 11. Precharge control signals VPO and VPE are alternately activated according to the timing signal instructing the switching of the gate line drive signal.

Precharge switch circuit 14 includes precharge switching elements (SP1O and SP1E) arranged corresponding to each data line in pixel matrix 10, and operates according to precharge control signals VPO and VPE received from precharge control circuit 13 to transmit precharge voltage VP to a data line different from a data line connected to a selected pixel out of the data lines DLiO and DLiE.

Switch control circuit 16 operates according to the timing signal received from gate line drive circuit 11, to produce a signal having its state inverted every write cycle, for selecting the even-numbered data lines or the odd-numbered data lines as the transmission paths of the output signals of write circuit 15.

Selection switch circuit 17 has selection switches SW (FIG. 5) corresponding to the respective pixel columns, and transmits the write current or the ground voltage provided from write circuit 15 to the data lines in the respective columns. Therefore, precharge control circuit 13 and switching control circuit 16 are configured to select the transmission paths by the corresponding switches in the opposite manners. When precharge control circuit 13 produces the control signal selecting an even-numbered data line, switching control circuit 16 sets its output signal to select an odd-numbered data line. When precharge control circuit 13 sets its output signal to select the even-numbered data line, switching control circuit 16 sets selection switch circuit 17 to select the odd-numbered data line.

These precharge control circuit 13 and switching control circuit 16 are each formed of, e.g., a one-bit counter or a T-flip-flop, and generate an output signal having its output signal state determined based on the timing signal produced by gate line drive circuit 11 according to horizontal clock signal HCLK.

According to the first embodiment of the invention, as described above, two data lines are arranged for each pixel column, and are configured such that one of the data lines is precharged to a predetermined precharge voltage level, and the other data line writes the pixel signal with a start voltage equal to the precharge voltage. Therefore, even after the black data writing, which was performed with the pixel signal at the ground voltage level, it is possible to increase the margin for the write time in the minimum write current writing operation.

Since the complete black display is achieved, it is possible to reduce the leak current and therefore the current consumption.

### Second Embodiment

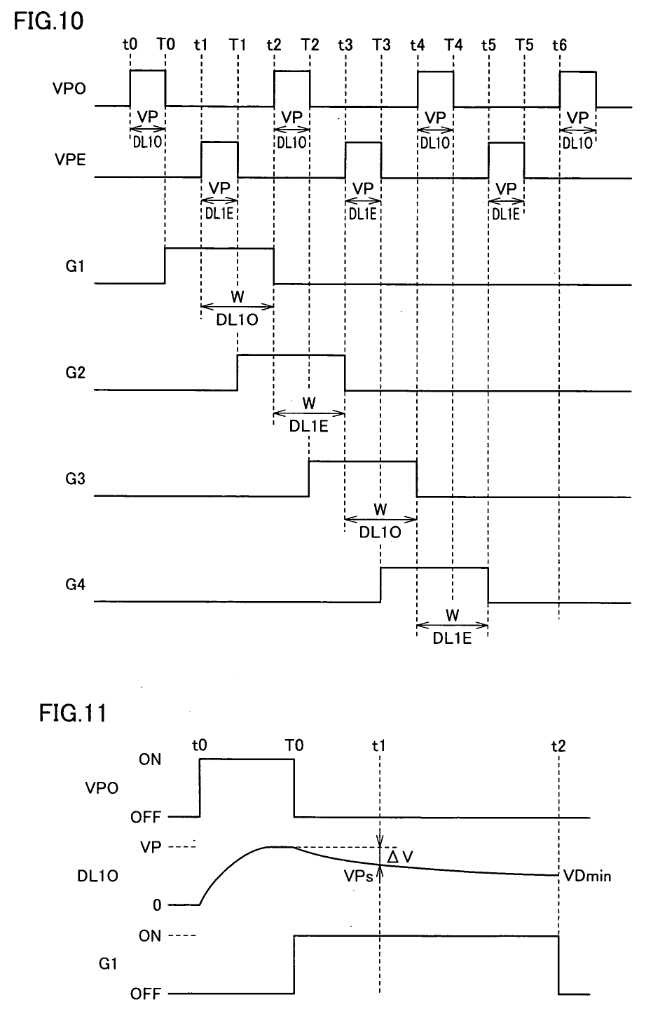

FIG. 10 is a timing diagram representing the data line precharging and the pixel signal write operation according to a second embodiment of the invention. The construction itself of the display device in the second embodiment is the same as that as shown in FIGS. 5 and 9.

As shown in FIG. 10, precharge control signals VPO and VPE are alternately activated at times t0, t1, t2, . . . . These precharge control signals VPO and VPE are alternately deactivated at times T0, T1, T2, T3, T4 . . . in an interval between adjacent times of times t0, t1, t2 . . . .

According to deactivation of precharge control signal VPO, gate line drive signals G (G1 and G3) for odd-numbered rows are driven to the selected state. According to deactivation of precharge control signal VPE, gate line drive signals G (G2 and G4) for the even-numbered rows are successively driven to the active state. Writing in the pixels is executed at times t0, t1, t2 . . . .

A period of the active state of gate line drive signals G (G1-G4) is longer than that in the first embodiment as previously described, and precharge voltage VP on the data line is discharged via the potential storage MOS transistor 2 in the pixel before actual writing of the pixel signal. Although the length of the time period, for which the write circuit actually transmits the pixel signal to the data line DL, is equal to that in the first embodiment, gate line GL is kept in the selected state for a longer time period than that in the first embodiment so that the write time for writing with the minimum write current can be effectively increased (precharge voltage VP is at the voltage level higher than the voltage level corresponding to the minimum write current value).

FIG. 11 illustrates a potential change of data line DL1O between times t0 and t2 illustrated in FIG. 10. At time t0 in FIG. 11, precharge control signal VPO attains the on state, i.e., active state (H level) to start the precharging of data line DL1O. In the diagram of FIG. 11, it is assumed that before time t0, data line DL1O is held at the ground voltage level, and the black data was written in the last cycle.

At time t0, precharge control signal VPO is made on to attain the L level. Accordingly, charging for data line DL1O starts, and data line DL1O attains the level of precharge voltage VP.

At time T0, gate line drive signal G1 is driven to the on state (H level). At this point in time, data line DL1O is not yet supplied with the write current. Therefore, the pixel arranged corresponding to the crossing between data line DL1O and gate line GL1 is in such a state that the internal node thereof is discharged via potential storage MOS transistor 2. At time t1, the voltage level of data line DL1O attains a voltage level VPs lower by ΔV than precharge voltage VP.

At time t1, the write current is supplied to data line DL1O. In the write operation starting from time t1, if minimum write current IEL1 is supplied, the internal node of the pixel can be set to the voltage level of the target voltage, i.e., minimum write voltage VDmin at a faster timing. Therefore, the write time can be effectively increased, and the margin of the write time with respect to the minimum write current can be increased.

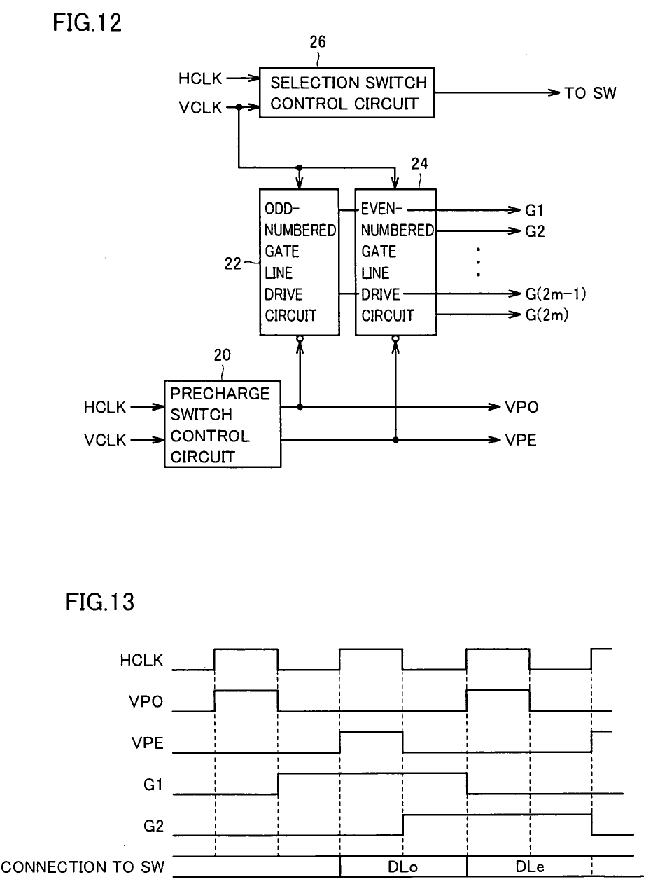

FIG. 12 schematically shows a construction of a control signal generating section of the display device according to the second embodiment of the invention. In FIG. 12, the control signal generating section includes a precharge switch control circuit 20 that produces precharge control signals VPO and VPE according to vertical and horizontal clock signals VCLK and HCLK, an odd-numbered gate line drive circuit 22 that is provided for odd-numbered gate lines G1, . . . G(2 m−1) and performs the shift operation in response to the falling of precharge control signal VPO to successively driving the odd-numbered gate lines to the selected state, an even-numbered gate line drive circuit 24 that is provided for even-numbered gate lines G2, . . . G(2 m) and performs the shift operation in response to the falling of precharge control signal VPE to successively drive the even-numbered gate lines to the selected state, and a selection switch control circuit 26 that produces a selection control signal for write selection switch SW according to vertical and horizontal clock signals VCLK and HCLK.

Precharge switch control circuit 20 is formed of a T-flip-flop that is reset according to vertical clock signal VCLK, and changes its output state according to horizontal clock signal HCLK. Odd- and even-numbered gate line drive circuits 22 and 24 are each formed of a shift register having an activation position set to an initial position in response to the activation of vertical clock signal VCLK, and performing the shift operation according to precharge control signals VPO or VPE.

Selection switch control circuit 26 is formed of, e.g., a T-flip-flop that has an output state reset according to the activation of vertical clock signal VCLK, and the output state changed according to horizontal clock signal HCLK. Selection switch control circuit 26 switches the connection between the write circuit and the data lines.

FIG. 13 is a timing chart representing an operation of a control signal generating section shown in FIG. 12. Referring to FIG. 13, an operation of the control signal generating section shown in FIG. 12 will be described.

When the display device is active, vertical clock signal VCLK defining one frame (one screen image) is activated in predetermined periods, and horizontal clock signal HCLK is generated in predetermined periods, so that the selection period of each gate line is defined. Precharge switch control circuit 20 changes its output state in response to the rising of horizontal clock signal HCLK, and alternately activates precharge control signals VPO and VPE.

Odd-numbered gate line drive circuit 22 performs the shift operation in response to the falling of precharge control signal VPO, and drives initial gate line drive signal G1 to the selected state.

In response to the rising of horizontal clock signal HCLK, selection switch control circuit 26 changes the connection state to transmit the write pixel signal to odd-numbered data line DLo. In parallel to the writing of the pixel signal to odd-numbered data line DLo, even-numbered precharge control signal VPE becomes active to execute the precharging on even-numbered data line DLe. When even-numbered data line precharge control signal VPE becomes inactive, even-numbered gate line drive circuit 24 performs the shift operation to drive gate line drive signal G2 for the first even-numbered gate line to the selected state. In accordance with the next rising of horizontal clock signal HCLK, selection switch control circuit 26 changes the connection state to transmit the write pixel signal to even-numbered data line DLe. After vertical clock signal VCLK is generated, selection switch control circuit 26 keeps write selection switch SW off for the precharge period in the initial cycle, to isolate data lines DLo and DLe from the write circuit. In the first write cycle, odd-numbered data line DLo is connected to the write circuit. When odd-numbered gate line GL1 is selected, the write current or the black data write voltage is transmitted to the selected pixel via the selected odd-numbered data line.

According to the second embodiment of the invention, as described above, the precharge period of the data line is reduced, and the pixel in the selected row is connected to the data line during this shortened precharge period of time. Therefore, the write time for writing the minimum write current in the selected pixel can be effectively increased, and it is possible to increase the margin for the write time.

### Third Embodiment

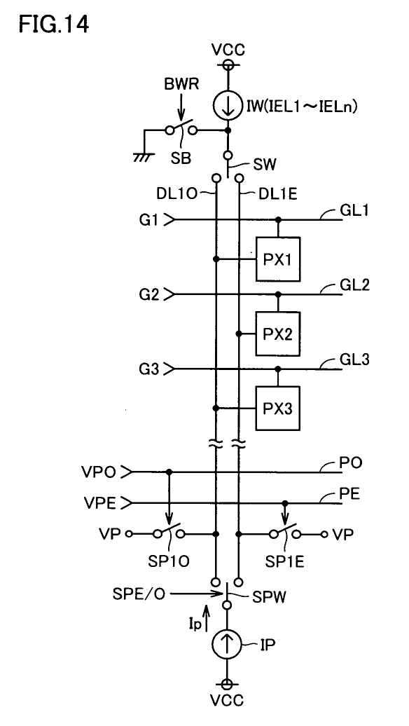

FIG. 14 schematically shows a construction of a main portion of a display device according to a third embodiment of the invention. In the display device shown in FIG. 14, a precharge current selection switch SPW is provided for the pair of data lines DL1O and DL1E in each column. Precharge current selection switch SPW supplies a precharge current Ip to the corresponding data line via a precharge constant current source IP (i.e., a constant current source for precharge). Precharge constant current source IP is coupled to the power supply node supplying a power supply voltage VCC, and supplies precharge current Ip of a predetermined magnitude.

Other configuration of the display device shown in FIG. 14 are the same as that of the display device shown in FIG. 5. Corresponding portions are allotted with the same reference numerals, and description thereof is not repeated.

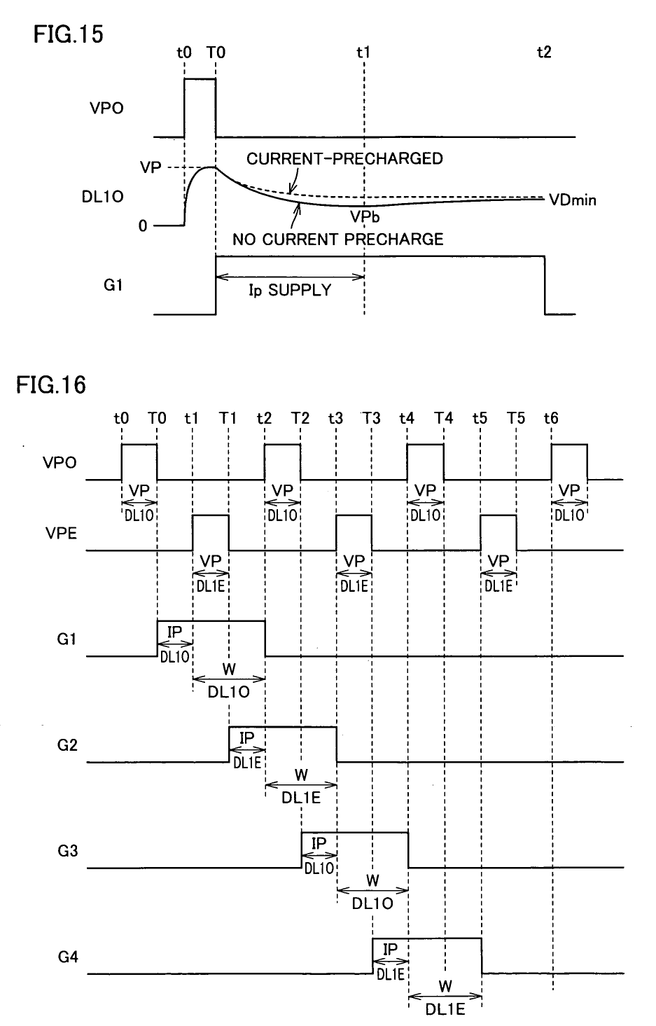

FIG. 15 is a timing chart representing an operation of the display device shown in FIG. 14. Referring to FIG. 15, the precharge and write operations of the display device shown in FIG. 14 will now be described.

At time t0, precharge control signal VPO becomes active, and precharge switching element SP1O is made conductive to transmit precharge voltage VP to odd-numbered data line DL1O. At this point in time, precharge selection switch SPW is isolated from both data lines DL1O and DL1E. By supplying precharge voltage VP, the voltage level of odd-numbered data line DL1O rises to the level of precharge voltage VP.

At time T0, precharge control signal VPO turns inactive, and odd-numbered data line precharge switching element SP1O is made off to isolate odd-numbered data line DL 10 from the precharge voltage supply.

At time T0, gate line drive signal G1 turns active to couple the internal node of pixel PX1 to odd-numbered data line DL1O. At this point in time, precharge selection switch SPW couples precharge constant current source IP to odd-numbered data line DL1O according to a precharge current control signal SPE/O. Thereby, precharge current Ip is supplied to data line DL1O, and suppresses the lowering of the potential of the internal node in selected pixel PX1.

At time t 1, write selection switch SW connects write constant current source IW to odd-numbered data line DL1O so that the write current is supplied from write constant current source IW to odd-numbered data line DL1O. When minimum write current IEL1 is supplied in this write operation, the internal node in the selected pixel PX1 is set to the level of voltage VDmin.

At time t2, gate line drive signal G1 turns inactive, and the writing to the pixel connected to gate line G1 is completed.

By the provision of precharge constant current source IP shown in FIG. 14, it is possible to suppress the discharging of the data line via the potential storing MOS transistor in the selected pixel when the precharged data line is connected to the pixel. Accordingly, it is possible to suppress the lowering of the potential of the internal node in the selected pixel, so that the internal node in the selected pixel can be rapidly set to the level of predetermined voltage VDmin when in the write operation with minimum write current IEL1.

If precharge constant current source IP were not present, data line DL1O and the internal node in the pixel would be discharged to a level of a voltage VPb lower than target voltage VDmin (finally approaching to VTN) as indicated by solid line in FIG. 5. For raising the lowered potential with minimum write current IEL1, a long period of time would be required until target voltage VDmin is reached, resulting in a reduced write margin. In the operation of writing with minimum write current IEL1, therefore, the precharge current can effectively increase the write time between time T0 and time t1, and thus can increase the margin of the write time. Therefore, the amount of precharge current Ip supplied by precharge constant current source IP is merely required to be equal to or smaller than minimum write current IEL1, and to satisfy the condition that the potential level of the internal node in the selected pixel is made equal to or higher than the voltage level of minimum write voltage VDmin at time t1. In particular, by setting the current value of precharge current Ip substantially equal to that of the minimum write current, such a situation is prevented that the voltage on the internal node lowers to or below the level of voltage VDmin corresponding to the minimum write current. Thus, the write time with the minimum write current can be substantially increased so that the write margin for the minimum write current can be increased.

FIG. 16 is a timing chart representing an operation of the display device according to the third embodiment of the invention. Referring to FIG. 16, the operation of the display device according to the third embodiment of the invention will now be described.

Precharge control signal VPO and VPE as well as gate line drive signal G are generated in the same sequence as that in the second embodiment already described. When precharge control signals VPO and VPE are inactive, the precharge constant current source supplies precharge current Ip to the data line, to which the precharge voltage was transmitted. Except for the supply of the precharge current from precharge constant current source IP, the transmission of precharge voltage VP and the operation of writing the pixel signal after the precharging are substantially the same as those in the second embodiment. The precharging and writing W of the pixel signal are successively effected on gate lines G1, G2, G3 and G4.

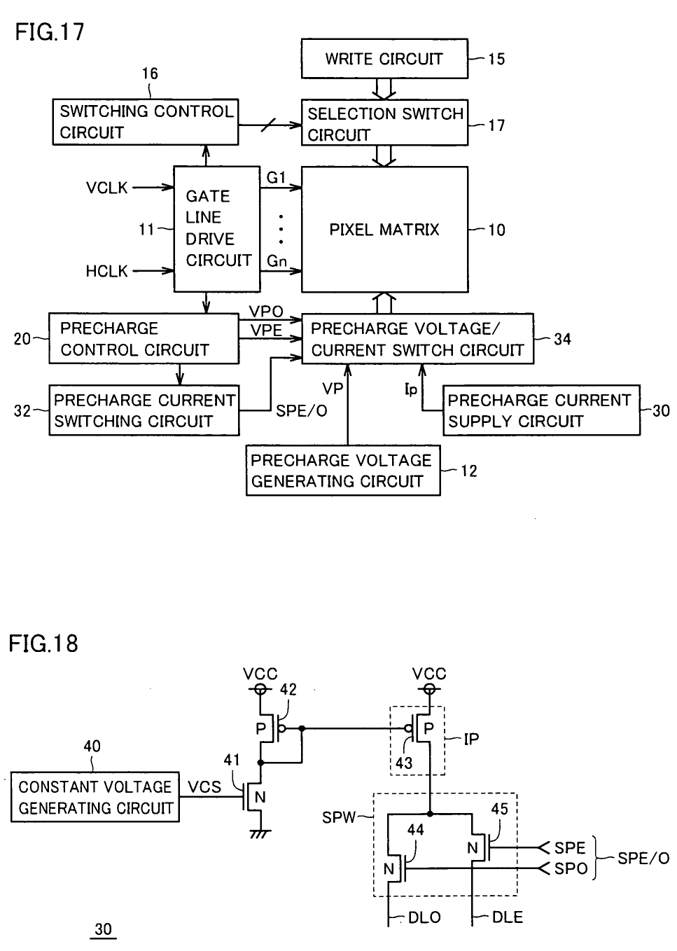

FIG. 17 schematically shows a whole construction of the display device according to the third embodiment of the invention. In FIG. 17, the display device includes a precharge current switching circuit 32 for producing precharge current switching control signal SPE/O according to the output signal of precharge control circuit 20, a precharge current supply circuit 30 including constant current sources arranged corresponding to the respective columns in pixel matrix 10 for supplying precharge current Ip, and a precharge voltage/current switch circuit 34 for switching the supplying paths of the precharge voltage and precharge current according to output signal SPE/O of precharge current switching circuit 32 and precharge control signals VPO and VPE received from precharge control circuit 20. Other constructions of the display device shown in FIG. 17 are the same as those of the display device shown in FIG. 9. Corresponding portions are allotted with the same reference numerals, and description thereof is not repeated.

Precharge voltage/current switch circuit 34 includes precharge switching elements SPiO and SP1E as well as precharge current selection switches SPW provided for the data lines in pixel matrix 10. After the precharge voltage is supplied to the data line precharged according to the precharge control signals VPO and VPE applied from precharge control circuit 20, precharge current supply circuit 30 supplies precharge current Ip to the same precharged data line according to output signal SPE/O of precharge current switching circuit 32.

FIG. 18 schematically shows an example of a construction of precharge current supply circuit 30 shown in FIG. 17. In FIG. 18, precharge current supply circuit 30 includes a constant voltage generating circuit 40 for generating a constant voltage VCS, an N-channel MOS transistor 41 receiving constant voltage VCS on its gate, a P-channel MOS transistor 42 supplying a current to MOS transistor 41, and precharge constant current source IP provided corresponding to each column in the pixel matrix.

MOS transistor 42 has a gate and a drain connected together, and supplies a current discharged to the ground node by MOS transistor 41.

Precharge constant current source IP is formed of, e.g., a P-channel MOS transistor 43 having a gate connected to the data of MOS transistor 42. MOS transistors 42 and 43 form a current mirror circuit. By setting constant voltage VCS and a mirror ratio of this current mirror circuit to appropriate values, respectively, it is possible to adjust the magnitude of precharge current Ip supplied by MOS transistor 43.

Precharge constant current source IP is coupled to precharge selection switch SPW. Precharge selection switch SPW includes an N-channel MOS transistor 44 provided corresponding to odd-numbered data line DLO (DL1O, . . . ) and an N-channel MOS transistor 45 provided corresponding to even-numbered data line DLE (DL2E, . . . ). MOS transistor 44 receives precharge control signal SPO on its gate, and MOS transistor 45 receives precharge control signal SPE on its gate. Precharge control signals SPE and SPO correspond to precharge control signal SPE/O shown in FIG. 14.

According to precharge control signals SPE and SPO, precharge constant current source IP supplies the precharge current to the selected data line.

In the construction of precharge current supply circuit 30 shown in FIG. 17, when both precharge control signals SPE and SPO are inactive, and selection switch SPW is off, precharge constant current source IP supplies the current to charge the output node of precharge constant current source IP to the level of power supply voltage VCC. Therefore, when the precharge control signal is active, a relatively large precharge current may flow as a rushing current. When such a large rushing current is likely to flow, it is merely required to provide an activation/inactivation control transistor for fixing the gates of MOS transistors 42 and 43 to the level of power supply voltage VCC when both precharge control signals SPE and SPO are inactive.

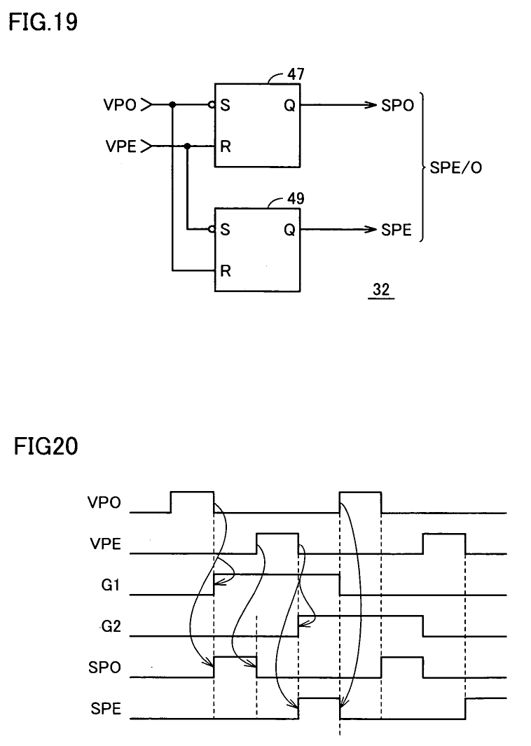

FIG. 19 shows an example of a construction of precharge current switching circuit 32 shown in FIG. 17. In FIG. 19, precharge current switching circuit 32 includes a set/reset flip-flop 47 that is set in response to the deactivation of precharge control signal VPO, is reset in response to the activation of precharge control signal VPE and generates a current switching control signal SPO from its output Q, and a set/reset flip-flop 49 that is set in response to the deactivation of precharge control signal VPE, is reset in response to the activation of precharge control signal VPO and produces a current switching control signal SPE from its output Q. These precharge current switching control signals SPO and SPE correspond to precharge current switching control signal SPE/O shown in FIG. 14.

FIG. 20 is a timing diagram representing an operation of precharge current switching circuit 32 shown in FIG. 19. Referring to FIG. 20, the operation of precharge current switching circuit 32 shown in FIG. 19 will now be described.

In response to the deactivation of precharge control signal VPO, the gate line drive signal (e.g., G1) for the odd-numbered gate line is driven to the active state. In response to the deactivation of precharge control signal VPO, set/reset flip-flop 47 is set to activate precharge current switching control signal SPO so that the precharge current is supplied to the odd-numbered data line. At this point in time, precharge current switching control signal SPE is inactive.

Subsequently, when precharge control signal VPE turns active, set/reset flip-flop 47 is reset to deactivate precharge current switching control signal SPO, so that supplying of the precharge current to the odd-numbered data line stops. In response to the deactivation of precharge control signal VPE, the gate line drive signal (e.g., G2) corresponding to the even-numbered gate line is driven to the selected state. In parallel with this, set/reset flip-flop 49 is set in response to the deactivation of precharge control signal VPE, and precharge current switching control signal SPE is activated to start the supplying of the precharge current to the even-numbered data line.

Subsequently, when precharge control signal VPO turns active again, set/reset flip-flop 49 is reset, and precharge current switching signal SPE turns inactive to stop the supplying of the precharge current to the even-numbered data line.

Precharge current switching signals SPO and SPE are produced by utilizing precharge control signals VPO and VPE. Thus, the precharge current can be accurately supplied to the data line, to which the precharge voltage is transmitted, before start of the writing.

According to the third embodiment of the invention, as described above, the precharge voltage supply period of the data line is short, the time period of the selected state of the gate line is made long and the precharge current is supplied in an initial stage of the long gate line selection period of time. Therefore, it is possible to prevent the lowering of the voltage level of the data line below minimum write voltage VDmin, and the write time of the minimum write current can be increased so that the margin of the write time of the minimum write current can be increased.

### Fourth Embodiment

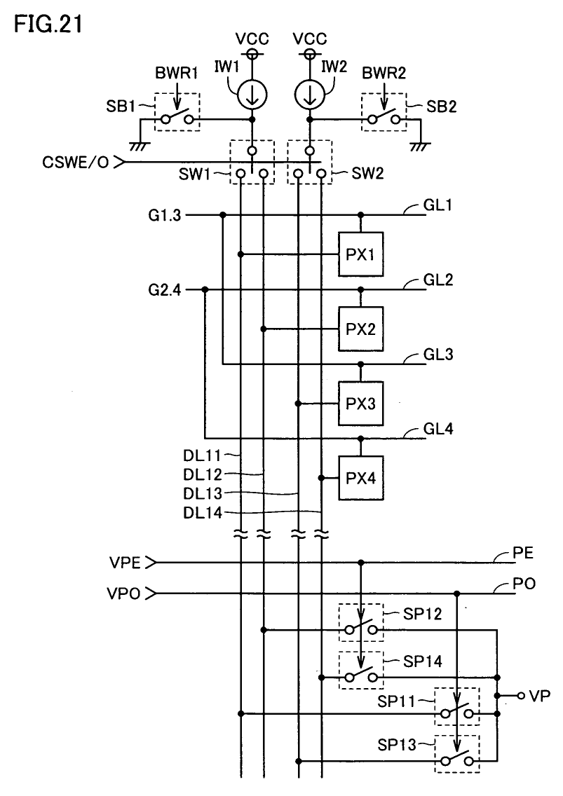

FIG. 21 schematically shows a construction of a main portion of the display device according to a fourth embodiment of the invention. FIG. 21 representatively shows a construction for pixels PX1-PX4 arranged in one column. In the construction shown in FIG. 21, four data lines DL11-DL14 are arranged parallel to each other for one pixel column. Pixels PX1-PX4 are connected to these data lines DL11-DL14, respectively. Data lines DL11 and DL12 are coupled to a write constant current source IW1 and a black data write switch SB1 via a write selection switch SW1, and data lines DL13 and DL14 are connected to a write constant current source IW2 and a black data write witch SB2 via a write selection switch SW2.

Black data write switches SB1 and SB2 are turned on to transmit the ground voltage in response to black data write instruction signals BWR1 and BWR2 in the black data write operation, respectively. Write constant current sources IW1 and IW2 supply the constant currents corresponding to the write pixel signal. Data lines DL11 and DL13 receive precharge voltage VP via precharge switching elements SP11 and SP13, respectively, and data lines DL12 and DL14 receive precharge voltage VP via precharge switching elements SP12 and SP14, respectively. Precharge switching elements SP11 and SP13 are selectively turned on according to precharge control signal VPO on precharge control signal line PO, and precharge switching elements SP12 and SP14 are selectively turned on according to precharge control signal VPE on precharge control signal line PE.

Gate lines GL1-GL4 are arranged corresponding to pixels PX1-PX4, respectively. In the arrangement of the gate lines, alternate gate lines are commonly connected to receive the same gate line drive signal. Thus, gate lines GL1 and GL3 receive a data line drive signal GL1.3, and gate lines GL2 and GL4 receive a gate line drive signal G2.4. Therefore, the pixel signals are written in the pixels arranged in the adjacent even-numbered rows or the adjacent odd-numbered rows in parallel.

In the display device shown in FIG. 21, with four adjacent pixels PX1-PX4 being a set, odd- or even-numbered rows are precharged in parallel with the writing of signals in the pixels in the even- or odd-numbered rows. Therefore, data line DL11 is connected to pixel PX(4 k+1), and data line DL13 is connected to pixel PX(4 k+2). Also, data lines DL13 is connected to pixel PX(4 k+3), and data line DL14 is connected to pixel PX(4 k+4). Here, the “k” represents an integer expressed by (0≦k≦n/4), with n being the number of gate lines GL.

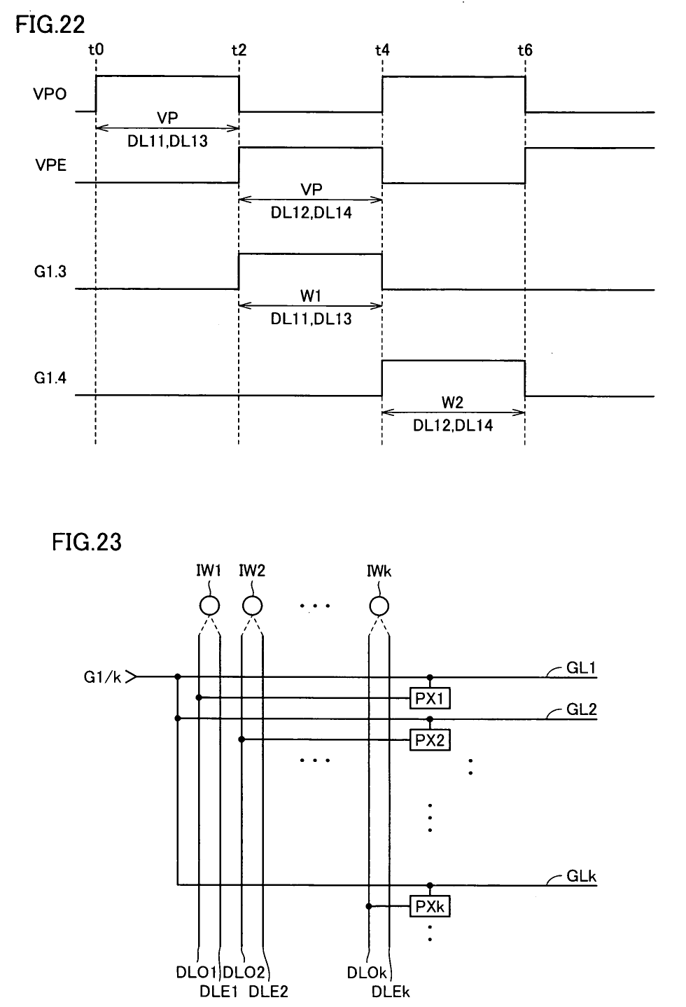

FIG. 22 is a timing chart representing the operations of precharging and writing the pixel signal in the display device shown in FIG. 12. Referring to FIG. 22, the precharging and writing operations of the display device shown in FIG. 21 will now be described. In FIG. 22, the time widths between times t0, t2, t4 and t6 are the same as those in FIG. 6.

At time t0, precharge control signal VPO turns active, and precharge switching elements SP11 and SP13 are turned on to transmit precharge voltage VP to data lines DL11 and DL13. During this operation, write selection switches SW 1 and SW2 are off, and isolate data lines DL11-DL14 from write constant current sources IW1 and IW2.

At time t2, precharge control signal VPO becomes inactive, and precharge control signal VPE becomes active. Precharge switching elements SP11 and SP13 are turned off, and precharge switching elements SP12 and SP14 are turned on to transmit precharge voltage VP to data lines DL12 and DL14.

Write selection switches SW1 and SW2 couple data lines DL11 and DL13 to write constant current sources IW1 and IW2 according to a write switching control signal CSWE/O. In this operation, a gate line drive signal G1.3 is driven to the selected state, and the write pixel signal is transmitted to pixels PX1 and PX3. For writing the black data, a black data write switch SP1 or SP2 is turned on to transmit the ground voltage to the corresponding data line according to black data write instruction signal BWR1 or BWR2. In this operation, corresponding write constant current source IW1 or IW2 is inactive, and is set to the output high impedance state.

When writing of the pixel signals in pixels PX1 and PX3, which are connected respectively to gate lines GL1 and GL3 is completed, precharge control signal VPE becomes inactive at a time t4, and precharge control signal VPO is driven to the active state. Further, gate line drive signal G10.3 turns inactive, and the internal nodes of pixels PX1 and PX3 connected to gate lines GL1 and GL3 are isolated from corresponding data lines DL11 and DL13, respectively.

When precharge control signal VPE turns inactive at time t4, gate line drive signal G2.4 is driven to the active state, and the internal nodes of pixels PX2 and PX4 connected to gate lines GL2 and GL4 are connected to corresponding data lines DL 12 and DL14, respectively. In this operation, write selection switches SW1 and SW2 couple data lines DL12 and DL14 to corresponding write constant current sources IW1 and IW2 according to write switching control signal CSWE/O, respectively, and black data write switches SB1 and SB2 are connected to data lines DL12 and DL14, respectively. Accordingly, the pixel signals are written in pixels PX2 and PX4 connected to gate lines GL2 and GL4, respectively.

At a time t6, gate line drive signal G2.4 is driven to the unselected state, and the precharging of data lines DL12 and DL14 restarts. Thereafter, this operation is repeated until the completion of the writing of the signals in the pixels connected to all the rows in the display device.

In the case of the display device shown in FIG. 21, the writing is simultaneously effected on the pixels in the two rows. However, the write time for the pixels in one row is set to twice as long as that in the write operation timing chart of FIG. 6. Therefore, the write time for each row is equivalent to the time in the case where only one data line is arranged. The write time for one screen image is longer by the time of the precharge period from time t0 to time t2 than that in the case of employing only one data line, but is even much shorter than the time required for writing of one screen image, and the pixel signals for one screen image can be written within the write time, which is substantially the same as the write time for one screen image in the case of employing only one data line.

As shown in FIG. 21, by simultaneously writing the signals in the pixels on two rows and doubling the write time, the sufficient write time can be reliably ensured, and the margin of the write time can be increased. The construction for producing the pixel signals for the two rows can be achieved by utilizing a two-line delay line of providing a delay of time period for scanning two lines, and the pixel signals or the write data can be produced in parallel for the odd-numbered data line pair or the even-numbered data line pair.

Write switching control signal CSWE/O for write selection switches SW1 and SW2 can be produced by a construction similar to that in the first embodiment (see FIG. 12).

Likewise, precharge control signals VPE and VPO can be produced by utilizing a construction similar to that in the first embodiment.

In the construction shown in FIG. 21, alternate gate lines are commonly connected for receiving the same gate line drive signal. However, such a construction may be employed that the gate lines (e.g., GL1 and GL2) in the adjacent rows are simultaneously supplied with the common gate line drive signal, to be driven to the selected state. Thus, precharging is simultaneously effected on pixels PX1 and PX2, and writing of the signals in pixels PX1 and PX2 are performed in parallel with each other. During the write operations of pixels PX1 and PX2, the precharge is effected on pixels PX3 and PX4. In the case where four data lines DL11-DL14 are employed, therefore, the connections between these data lines and the pixels in the respective rows can be arbitrarily set unless a conflict occurs between the precharge operation and the write operation.

[Modification]

FIG. 23 schematically shows a construction of a modification of a fourth embodiment of the invention. Referring to FIG. 23, data lines DL01 and DLE1-DLOk and DLEk are arranged for pixels PX1-PXk arranged in one column. Write constant current source IW1 is provided for data lines DL01 and DLE1, and write constant current source IW2 is provided for data lines DLO2 and DLE2. Gate lines GL1-GLk connected to respective pixels PX1-PXk commonly receive a gate line drive signal G1/k. Pixels PX1-PXk are connected to data lines DLO1-DLOk, respectively.

Data lines DLE1-DLEk are connected to the pixels in other k columns (not shown), respectively. In the construction shown in FIG. 23, the pixels in the k columns are handled as one unit for performing the precharging and writing. Therefore, the write time can be k times larger than that in the case employing only one data line, and thus the margin of the write time can be increased substantially k times.

In FIG. 23, the precharge switches transmitting precharge voltage VP are provided corresponding to data lines DLO1 and DLE1-DLOk and DLEk, and the writing and the precharging are alternately executed.

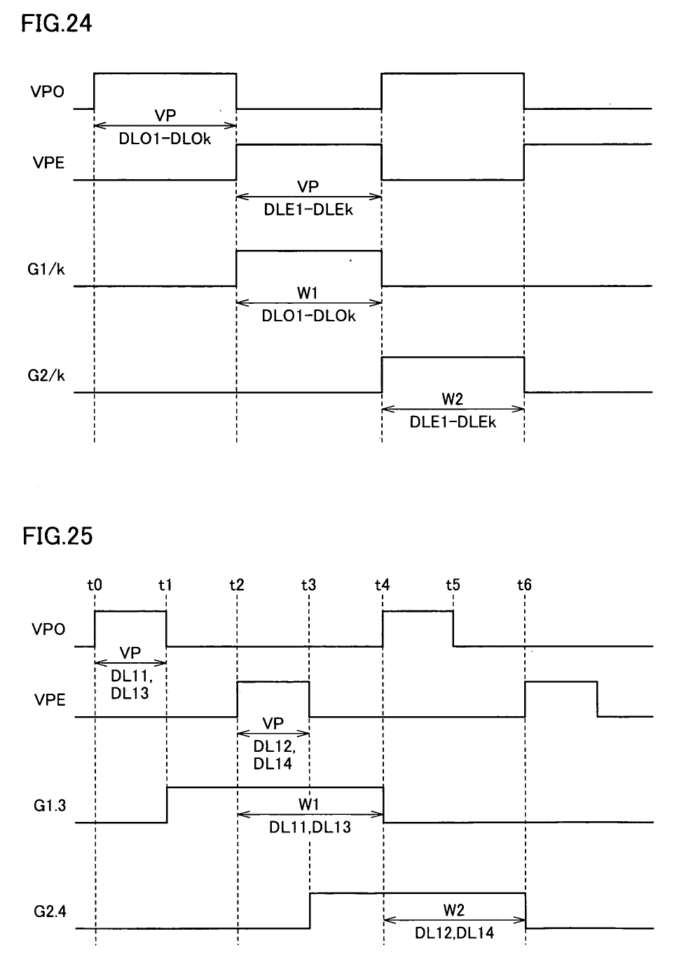

FIG. 24 is a timing chart representing an operation of the display device shown in FIG. 23. As shown in FIG. 24, the transmission of precharge voltage VP and writing W of the pixel signals are alternately effected on the set of odd-numbered data lines DLO1-DLOk and the set of even-numbered data lines DLE1-DLEk. When gate line drive signal G1/k is active, precharge control signal VPE turns active to effect the precharging on even-numbered data lines DLE1-DLEk in parallel with the writing in odd-numbered data lines DLO1-DLOk. Conversely, when gate line drive signal G2/k is active, precharge control signal VPO turns active to effect the precharging on odd-numbered data lines DLO1-DLOk in parallel with the writing in even-numbered data lines DLE1-DLEk.

According to the fourth embodiment of the invention, as already described, the plurality of pairs of data lines are arranged for the pixels arranged in one column, and the writing or precharging is simultaneously effected on the pixels in the plurality of rows so that the write time for the pixels can be increased, and the write time margin can be increased.

### Fifth Embodiment

FIG. 25 is a timing chart illustrating the precharging and writing operations of a display device according to a fifth embodiment of the invention. The display device has the same construction as that of the fourth embodiment shown in FIG. 21. More specifically, four data lines are arranged for each pixel column, and each of the precharging and the write current transmission is effected with two data lines being a unit.

In the timing chart of FIG. 25, the active periods of precharge control signals VPO and VPE are short, similarly to the case in the second embodiment. Specifically, precharge control signal VPO is active for a time period between times t0 and t1, and precharge control signal VPE is active for a time period between times t2 and t3. In response to the deactivation of precharge control signals VPO and VPE, gate line drive signals G1.3 and G2.4 become active. The actual data writing is effected on data lines DL11 and DL13 for a period between times t2 and t4, and is effected on data lines DL12 and DL14 for a period between times t4 and t6, similarly to the previous described embodiment.

By performing the precharging and writing according to the operation timing as represented in FIG. 25, precharge voltage VP on the data line can be discharged via the potential storing MOS transistor in the pixel before the writing (i.e., at a time between times t1 and t2) in the operation of writing the signal in the pixel. Accordingly, the write time for the minimum write current can be effectively increased, and the internal node in the pixel can reliably attain the voltage level of minimum write voltage VDmin even when the minimum write current is supplied. Therefore, in the operation of simultaneously writing the pixel signals in the pixels arranged in the plurality of rows, the pixel signals can be written stably even when the number of pixels is increased and accordingly each write cycle time is made short.

Similarly to the fourth embodiment, the gate line drive circuit has output nodes halved in number, and therefore has a reduced layout area.

In the fifth embodiment, the constructions for generating precharge control signals VPO and VPE as well as gate line drive signals such as gate line drive signals G1.3, G2.4, and the controlling of data write selection switches SW can be achieved by utilizing the constructions of the control section used in the second embodiment previously described. It is merely required to make the active period of each control signal and the active period of each gate line drive signal longer than those in the second embodiment.

For the construction shown in FIG. 23, in which 2·k data lines and k write constant current sources are provided for each pixel column, and the precharging switch (i.e., switch for precharge) is arranged for each data line, the driving manner of this fifth embodiment can be applied.

### Sixth Embodiment

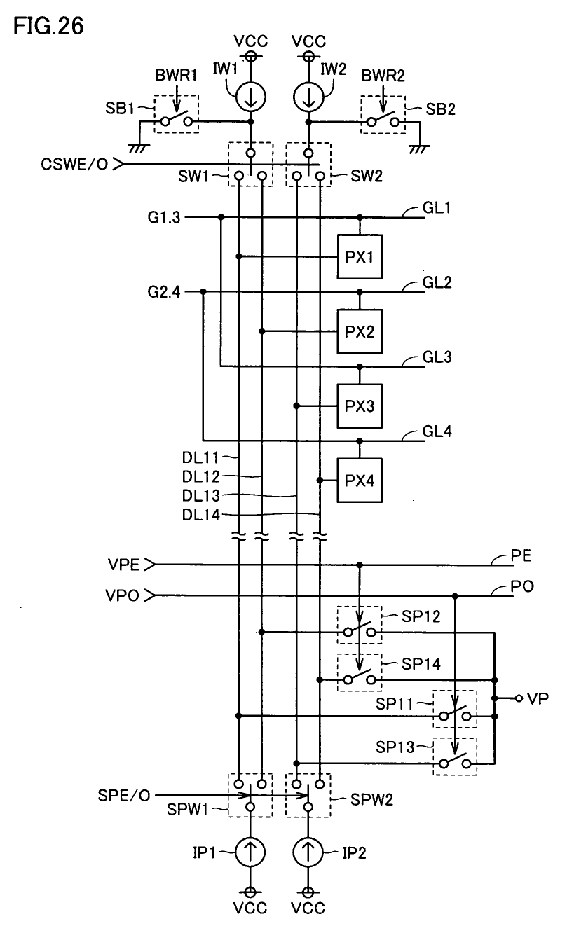

FIG. 26 schematically shows a construction of a main portion of a display device according to a sixth embodiment of the invention. The display device shown in FIG. 26 differs from the display device shown in FIG. 21 in the following construction. In FIG. 26, data lines DL11 and DL12 are coupled to a precharge constant current source IP11 via a precharge switching element SPW1, and data lines DL13 and DL14 are coupled to a precharge constant current source IP2 via a precharge switching element SPW2. These precharge switching elements SPW1 and SPW2 are commonly supplied with precharge current switching control signal SPE/O.

Other construction of the display device shown in FIG. 26 are the same as in the display device shown in FIG. 21. Corresponding portions are allotted with the same reference numerals, and description thereof is not repeated.

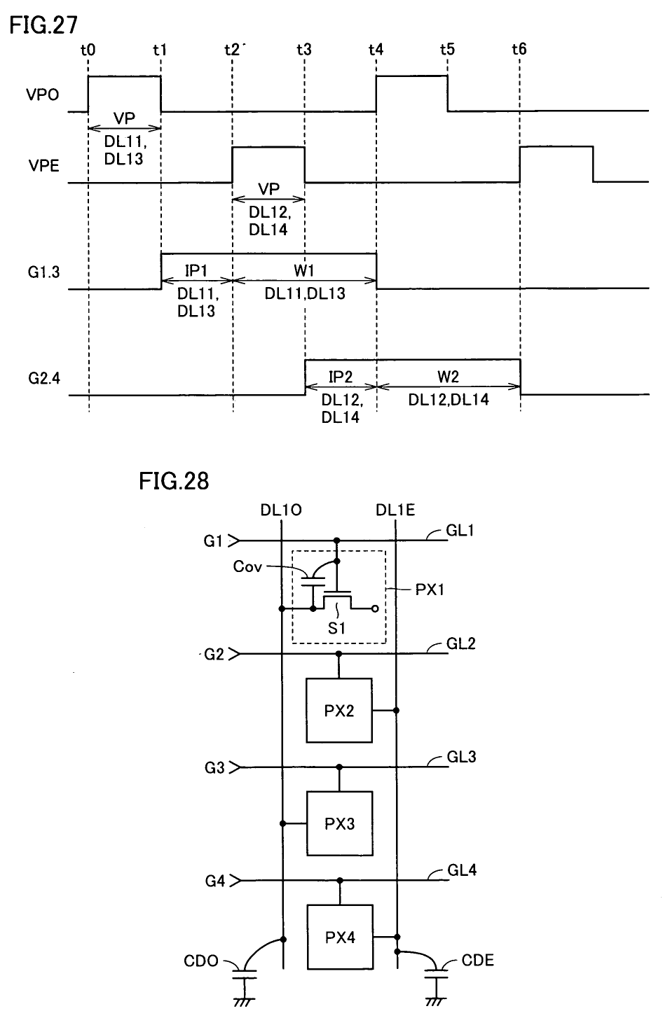

FIG. 27 is a timing chart representing the precharge and write operations of the display device shown in FIG. 26. Referring to FIG. 27, the precharge and write operations of the display device shown in FIG. 26 will now be described briefly.

Precharge control signals VPO and VPE are kept active for a period of half the write cycle time. When precharge control signal VPO becomes inactive at time t1, precharge current switching control signal SPE/O is set to the state for selecting data lines DL11 and DL13, and precharge switching elements SPW1 and SPW2 couple precharge constant current sources IP1 and IP2 to data lines DL11 and DL13, respectively. At time t1, gate line drive signal G0.3 is driven to the selected state.

When precharge control signal VPE turns active at time t2, precharge current switching control signal SPE/O turns inactive, and the switches SPW1 and SPW2 are turned off to isolate precharge constant current sources IP1 and IP2 from data lines DL1-DL14. In a period starting from this time t2, write constant current sources IW1 and IW2 or black data write switches SB1 and SB2 are used to perform the writing of the pixel signals.

When precharge control signal VPE turns inactive at time t3, precharge current switching control signal SPE/O is set to the state for selecting data lines DL 12 and DL14 again, and precharge switching elements SPW1 and SPW2 couple the precharge constant current sources IP1 and IP2 to data lines DL12 and DL14, respectively.

When precharge control signal VPO turns active again at time t4, precharge current switching control signal SPE/O turns inactive, and precharge switching elements SPW1 and SPW2 are turned off to isolate constant current sources IP1 and IP2 from data lines DL11-DL14. At time t3, gate line drive signal G2.4 is driven to the active state, and the internal node of the selected pixel is precharged. At time t4, write constant current sources IW1 and IW2 or black data write switches SB1 and SB2 operate to write the data in the selected pixel.

In the construction of the display device shown in FIG. 26, the actual write cycle period can be increased. Therefore, if the transmission time of precharge voltage VP is reduced, the potential of the internal node in the pixel may lower significantly below target voltage VDmin. During this period, however, precharge constant current sources IP1 and IP2 are coupled to supply the currents to the data lines connected to the write pixels, for suppressing the potential lowering of the internal node in the selected pixel. Therefore, fast writing can be achieved even with the minimum write current.

The construction of utilizing the precharge current can be applied to the construction with k write constant current sources and 2·k data lines, as shown in FIG. 23.

The construction of the display device shown in FIG. 26 is substantially a combination of the third and fourth embodiments, and can achieve the effects similar to those of the third and fourth embodiments.

### Seventh Embodiment

FIG. 28 schematically shows a construction of a main portion of the display device according to a seventh embodiment of the invention. In FIG. 28, data lines DL1O and DL1E are arranged on the opposite sides of one column including pixels PX1-PX4.

In the arrangement of the data lines shown in FIG. 28, a crossing is not present between data lines DL1O and DL1E, so that a coupling capacitance is not present between data lines DL1O and DL1E. Therefore, parasitic capacitances CDO and CDE present on data lines DL1O and DL1E can be made smaller than those in the arrangement of the data lines of the first embodiment so that data lines DL1O and DL1E can be charged and discharged fast.

The switching element (see FIG. 1) in the pixel is usually formed of an N-channel MOS transistor as shown in FIG. 28. FIG. 28 representatively shows switching element S1 in pixel PX1. In switching element S1 formed of the MOS transistor, an overlap capacitance (parasitic capacitance) Cov is formed in a region, where a gate electrode overlaps a drain/source electrode. Each of data lines DL1O and DLLE is connected to only half of the pixels arranged in one column, and the number of overlap capacitances Cov connected to each of data lines DL1O and DL1E can be halved as compared with the construction provided with only one data line for each column. Therefore, it is possible to reduce the capacitance values of parasitic capacitances CDO and CDE, and therefore to reduce the write time.

In the seventh embodiment, the construction of precharging the data lines and writing the pixel signals may be achieved by the use of the construction in any of the first to third embodiments.

According to the seventh embodiment, as described above, the data lines are arranged on the either sides of the pixels arranged in one column, and the parasitic capacitances of these data lines can be reduced so that the data lines can be charged and discharged fast, and the write time can be reduced.

### Eighth Embodiment

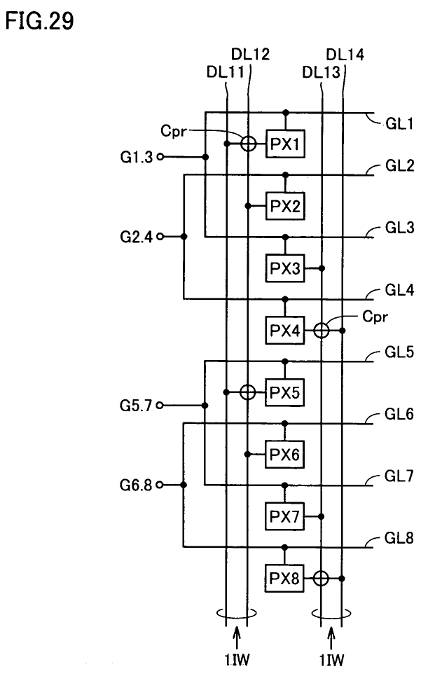

FIG. 29 schematically shows a construction of a main portion of a display device according to an eighth embodiment of the invention. Referring to FIG. 29, data lines DL11 and DL12 are arranged on one side of a column including pixels PX1-PX8, and data lines DL13 and DL14 are arranged on the other side of the column including pixels PX1-PX8. Gate lines GL1 and GL3 are commonly supplied with gate line drive signal G1.3, and gate lines GL2 and GL4 are commonly supplied with gate line drive signal G2.4. Likewise, gate lines GL5 and GL7 are supplied with a gate line drive signal G5.7, and gate lines GL6 and GL8 are supplied with a gate line drive signal GL6.8.

Data lines DL11 and DL12 share write constant current source IW and the black data write switch as shown in FIG. 26, and data lines DL13 and DL14 share write constant current source IW and the black data write switch. Pixels PX1-PX4 are connected to data lines DL11-DL14, respectively, and pixels PX5-PX8 are connected to data lines DL11-DL14, respectively.

In the arrangement shown in FIG. 29, data line DL12 overlaps an interconnection line connecting data line DL11 to pixel PX1 so that a parasitic capacitance Cpr is formed. Likewise, an interconnecting line connecting pixel PX4 to data line DL14 crosses data line DL13 to form parasitic capacitance Cpr. Therefore, each of data lines DL11-DL14 forms only one crossing per four pixels, so that the coupling capacitances between interconnection lines can be made smaller than those in the construction, in which all data lines DL11-DL14 are arranged on one side. Thus, the capacitance value of interconnection capacitance CD of these data lines DL11-DL14 can be reduced.

[Modification]

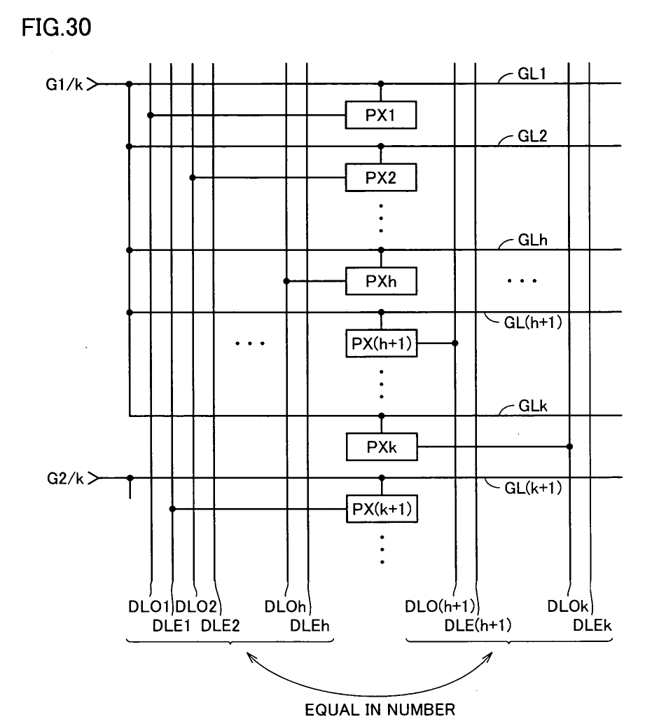

FIG. 30 schematically shows a construction of a modification of the eighth embodiment of the invention. In FIG. 30, data lines DLO1 and DLE1-DLOh and DLEh are arranged on one side of the column including pixels PX1-PX(k+1), and data lines DLO(h+1) and DLE(h+1)-DLOk and DLEk are arranged on the other side. Pixels PX1-PXk are connected to data lines DLO1-DLOk, respectively, and pixel PX(k+1) is connected to data line DLE1. Gate lines GL1-GLk arranged corresponding to respective pixels PX1-PXk commonly receive gate drive signal G1/k. Gate line GL(k+1) arranged for pixel PX(k+1) receives gate line drive signal G2/k.

Data lines DL01 and DLE1-DLOh and DLEh are equal in number to data lines DLO(h+1) and DLE(h+1) DLOk and DLEk.

According to the arrangement shown in FIG. 30, the number of crossings between the data lines can be reduced, as compared with the construction in which data lines DLO1 and DLE1-DLOk and DLEk are arranged on one side of the pixel column, and therefore the parasitic capacitance of the data lines can be reduced.

In the construction shown in FIG. 30, the same gate drive signal may be applied to the gate lines spaced by k rows from each other. It is not particularly required to transmit the same gate line drive signal to the set of the gate lines in the adjacent rows, and it is merely required to prevent a conflict between the precharging of the data line and the writing of the pixel signal.

The construction in the eighth embodiment can likewise achieved with any construction in the fourth to sixth embodiments for the data line precharging and the writing.

According to the eighth embodiment of the invention, as described above, the data lines are arranged on the opposite sides of the pixels arranged in one column, and therefore the crossings between the data lines can be reduced in number so that the line capacitance of the data lines can be reduced, and fast writing can be performed.

### Ninth Embodiment

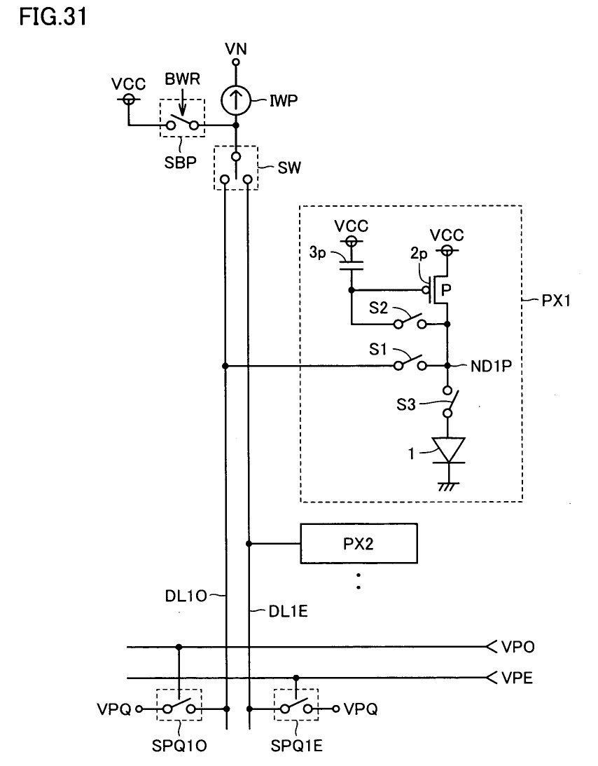

FIG. 31 schematically shows a construction of a main portion of a display device according to a ninth embodiment of the invention. The display device shown in FIG. 91 uses a P-channel MOS transistor 2p as a potential storing element of pixel PX1. FIG. 31 representatively shows an internal construction of pixel PX1. Pixel PX1 includes a P-channel MOS transistor 2p connected between the power supply node and an internal node ND1P, switching element S1 selectively made conductive to connect internal node ND1P to data line DL1O in response to a signal on the corresponding gate line (not shown), switching element S2 selectively made conductive to connect internal node ND1P to the gate of MOS transistor 2p in response to a signal on the corresponding gate line, a capacitance element 3p connected between the power supply node and the gate of MOS transistor 2p, switching element S3 made conductive complementarily to switching elements S1 and S2, and EL element 1 connected between switching element S3 and the ground node. The power supply node is supplied with power supply voltage VCC.

Write current selection switch SW is provided for data lines DL1O and DL1E. A write constant current source IWP and a black data write switch SBP are connected in parallel to write current selection switch SW. In the operation of writing the data pixel signal, write constant current source IWP discharges the current from the data line, which is connected via write current selection switch SW, to a row-side power supply node VN. Black data write switch SBP transmits power supply voltage VCC to the selected data line via write current selection switch SW when black data write instruction signal BWR is active.

Precharge switching elements SPQ1O and SPQ1E are provided for data lines DL1O and DL1E, respectively. Precharge switching elements SPQ1O and SPQ1E transmit a precharge voltage VPQ to data lines DL10 and DL1E when precharge control signals VPO and VPE are active, respectively.

Data line DL1E is connected to pixel PX2 in the adjacent row.

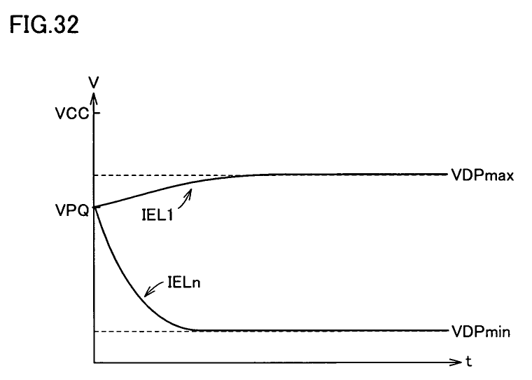

FIG. 32 shows the precharge and data write operations of the display device shown in FIG. 31. Referring to FIG. 32, description will now be given on the operations of precharging and image signal writing for pixel PX1 shown in FIG. 31.

Data line DL1O is precharged to the level of precharge voltage VPQ. Precharge voltage VPQ is lower than a voltage (minimum value write voltage) VDPmax corresponding to minimum write current IEL1 of internal node ND1P. With variations in threshold voltage VTP of MOS transistor 2p being taken into account, precharge voltage VPQ is set to satisfy the following condition:
VPQ≦MIN(VDPmax).

Since minimum value write voltage VDPmax changes depending on threshold voltage VTP, precharge voltage VPQ is set to the voltage level equal to or lower than the minimum value of minimum value write voltage VDPmax. In this state, when write constant current source IWP is connected to pixel PX1 for driving the current, one of constant currents IEL1-IELn is discharged according to the write data. By this discharging operation of write constant current source IWP, the potential of internal node ND1P of pixel PX1 is set to the voltage level corresponding to current IEL driven by write constant current source IWP (i.e., the gate and drain of MOS transistor 2p are connected together, and MOS transistor 2p operates in a diode mode to supply the current of a magnitude corresponding to the discharging current). In the case of setting precharge voltage VPQ to or below maximum write voltage VDPmax, when driving minimum write current IEL1, the data line is charged by using transistor 2p in the pixel. As for the current driving power of transistor 2p in the pixel, it is possible to utilize the transistor of the sizes similar to an area of the pixel, similarly to the case of using the N-channel MOS transistor, and even for driving minimum write current IEL1, the transistor 2p in the pixel can drive the internal node from precharge voltage VPQ to the level of minimum value write voltage VDPmax within a short time. In the case of driving of other write current IEL2 to current IELn, the current value is large, and the data line and internal node ND1P are rapidly discharged to the voltage level corresponding to the write current, to attain the desired voltage level. Thereby, the voltage level of the data line can be set, regardless of the write current value, to the voltage level corresponding to the write data (pixel signal) within a short time according to the driving current of write constant current source IWP in the pixel signal write operation.

When the write operation is completed, switching elements S1 and S2 are turned off, and then switching element S3 is turned on. Capacitance element 3p holds the write voltage, and MOS transistor 2p supplies a current corresponding to the write current to EL element 1. EL element 1 has a current driving power enough to enable MOS transistor 2p to operate in the saturation region. Therefore, EL element 1 emits the light by driving the current corresponding to the write current.

When write constant current source IWP discharges minimum write current IEL1, precharge voltage VPQ is gradually discharged, and the voltage level of internal node ND1P reaches voltage VDPmax corresponding to minimum write current IEL1. When the write current is maximum write current IELn, the voltage level of node ND1P rapidly reaches voltage a VDPmin. This voltage VDPmin may be at the level of the ground voltage.

Black data write switch SBP, when conductive, transmits power supply voltage VCC, and internal node ND1P in the selected pixel attains the level of power supply voltage VCC. Accordingly, MOS transistor 2p has the same potential at its gate and at the source, and thus maintains the off state.

If the precharge current is supplied to data lines DL1O and DL1E in the construction, which is configured to drive the gate line to the active state before the writing for effectively increasing the write time, such a situation is prevented that the charging is performed via MOS transistor 2p to raise the voltage level of precharge voltage VPQ (up to the level of maximum (VCC−|VTP|), by supplying the precharge current to the data line in the direction of discharging the data line.

In the case of utilizing P-channel MOS transistor 2p as the MOS transistor for holding and storing the potential, the operations similar to those as represented in the operation waveforms of FIG. 15 can be performed. Specifically, transistor 2p in the pixel can charge internal node ND1P to the voltage level that is higher than precharge voltage VPQ and is near the voltage level corresponding to the voltage (minimum value write voltage) VDPmax corresponding to the minimum write current IEL1. Thus, internal node ND1P can rapidly attain the voltage level corresponding to minimum write current IEL1. In this case, if the transistor 2p in the pixel excessively raises the charged potential above the target level, the subsequently supplied precharge current can lower the raised voltage level of internal node ND1P to reduce a difference between the charged potential and minimum value write voltage VDPmax. Therefore, even if precharge voltage VPQ is set to the voltage level lower than the internal node potential defined by minimum write current IEL1, the data writing can be performed fast, similarly to the case of utilizing the N-channel MOS transistor as the current drive transistor of the pixel.

As described above, in the construction utilizing the P-channel MOS transistor as the transistor for current setting in the pixel, it is possible to utilize the foregoing construction, which effectively increases the write time by increasing the gate selection period in the case of utilizing N-channel MOS transistor 2 as the transistor in the pixel. As a circuit for achieving the operation of adjusting the gate selection period, it is possible to utilize the construction of the control circuit employed in the foregoing case of utilizing the N-channel MOS transistor.

A plurality of data line pairs may be arranged for each pixel column. In this case of utilizing the plurality of data line pairs, it is possible to achieve the operations similar to those in the case of utilizing the N-channel MOS transistor as the pixel transistor.

According to the ninth embodiment, as described above, the P-channel MOS transistor is used in the pixel element, and particularly as the potential storing transistor, and, the precharging of the data lines and the transmission of the write pixel signals are sequentially performed so that the data writing can be performed fast.

The invention can be applied to the display device utilizing the electro-luminescence elements as the light emitting elements, and can be applied to the display device utilizing the organic EL elements or the like as the pixel elements.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A display device comprising:
a plurality of pixels, arranged in rows and columns, each including a light emitting element having a light emitting state set by its own driving current;
write circuitry for performing writing on at least one first pixel in a same column according to write data in a common write cycle; and
precharge circuitry for performing precharging on a pixel located in the same column as and in a different row from a row of said first pixel in parallel with the writing onto said first pixel.

2. The display device according to claim 1, wherein
each of the pixels includes an insulated gate transistor for determining an amount of current flowing through a corresponding light emitting element according to the write data,
said precharge circuitry includes a constant voltage supply for supplying a constant voltage of a certain magnitude, and
said constant voltage of the certain magnitude is at a level of a voltage not lower in an absolute value than a minimum write voltage of the write data supplied to said insulated transistor on the basis of a potential of a source of the transistor, and said minimum write voltage defines a minimum value of the current amount of a significant magnitude flowing through said light emitting element.

3. The display device according to claim 1, wherein
each of said pixels includes an insulated gate transistor for determining an amount of a current flowing through a corresponding light emitting element according to the write data, and
said precharge circuitry includes:
a constant current source for supplying a constant voltage greater in absolute value than a voltage defining a significant minimum value of an amount of a driving current of a corresponding light emitting element supplied to said insulated gate transistor, on the basis of a source potential of said transistor, and
a constant current source for supplying a constant current substantially the same in magnitude as said significant minimum value.

4. The display device according to claim 1, further comprising:
a plurality of gate lines, arranged corresponding to the pixel rows, each transmitting a signal selecting the pixels in a corresponding row; and
a gate line drive circuit having output nodes each provided for a predetermined number of the gate lines, and transmitting gate line control signal of a common waveform to each predetermined number of gate lines.

5. The display device according to claim 4, wherein
the data lines of a number twice as large as said predetermined number are arranged for each pixel column,
one of a precharging operation and a write operation is commonly effected on the pixels arranged in a same column and corresponding to said predetermined number of the gate lines, and
a set of said predetermined number of the data lines is utilized for precharging, and another set of the predetermined number of the data lines is utilized for data writing.

6. A display device comprising:
a plurality of pixels, arranged in rows and columns, each including a light emitting element having a light emitting state set by its own driving current;
a plurality of data lines arranged corresponding to the pixel columns such that at lease one pair of the data lines is present per column;
a plurality of precharge circuits, arranged corresponding to the pixel columns such that at lease one pair of the precharge circuits is present per column, each for supplying a precharge voltage to a corresponding data line;
a plurality of display data write current supply circuits, arranged corresponding to said pixel columns such that at lease one display data write current supply circuit is present per column, each, when made active, for supplying a current of a magnitude corresponding to write data to a corresponding column; and
black data write circuits, arranged corresponding to the data lines, each, when made active, for transmitting a potential setting a corresponding data line to a state stopping current driving of the light emitting element in a selected pixel.

7. The display device according to claim 6, further comprising:
a plurality of precharge current supply circuits, arranged corresponding to the pixel columns, each for supplying a precharge current of a certain magnitude to the data line in a corresponding column according to a precharge instruction signal.

8. The display device according to claim 6, wherein
each pixel includes a transistor for determining an amount of a current flowing through a corresponding light emitting element according to write data, and
said black data write circuits each transmit a potential for turning off said transistor to a corresponding data line.

9. The display device according to claim 6, wherein
each pixel includes an insulated gate transistor for determining an amount of current flowing through a corresponding light emitting element according to write data,
said precharge circuits each include a constant voltage supply for supplying a constant voltage of a certain magnitude, and
said constant voltage of the certain magnitude is at a level of a voltage not smaller in absolute value than a minimum write voltage of the write data supplied to said transistor on the basis of a potential of a source of said transistor, said minimum write voltage defining a minimum value of the current amount of a significant magnitude flowing through the light emitting element.

10. The display device according to claim 6, wherein
each pixel includes an insulated gate transistor for determining an amount of a current flowing through a corresponding light emitting element according to write data, and
the precharge currents each includes:
a constant current source for supplying a constant voltage greater in absolute value than a minimum write voltage defining a significant minimum value of an amount of a driving current of a corresponding light emitting element supplied to said transistor, with reference to a source potential of said transistor, and
a constant current source for supplying a constant current of a substantially same magnitude as said significant minimum value.

11. The display device according to claim 6, wherein
said at least one pair of the data lines includes the data lines arranged on either sides of a corresponding column of the pixels, respectively, and the data lines in the pair are alternately coupled to a common write circuit and a common precharge circuit.

12. The display device according to claim 6, further comprising:
a plurality of gate lines, arranged corresponding to the pixel rows, each transmitting a signal of selecting the pixels in a corresponding row; and
a gate line drive circuit having output nodes each provided corresponding to a predetermined number of the gate lines, and transmitting gate line control signals of a same waveform to each predetermined number of gate lines.

13. The display device according to claim 12, wherein
the data lines of a number twice as large as said predetermined number are arranged for each pixel column,
one of a precharging operation and a write operation is commonly effected on the pixels arranged, in a same column, corresponding to the predetermined number of gate lines, and
in each column of the pixels, a set of said predetermined number of data lines is utilized for precharging, and another set of the predetermined number of the data lines is utilized for data writing.
